(19) United States
(12) Patent Application Publication
(10) Pub. No.: US 2023/0351464 A1
(43) Pub. Date: Nov. 2, 2023

(54) SYSTEM AND METHOD FOR VERIFIABLY STORING DIGITAL DATA RELATING TO ITEMS AND EVENTS

(71) Applicant: Francis Beausoleil, Laval (CA)

(72) Inventor: Francis Beausoleil, Laval (CA)

(21) Appl. No.: 18/309,035

(22) Filed: Apr. 28, 2023

Related U.S. Application Data
(60) Provisional application No. 63/335,996, filed on Apr. 28, 2022.

(51) Int. Cl. G06Q 30/0601; G06Q 40/02; G06Q 20/38

(52) U.S. Cl. CPC G06Q 30/0611; G06Q 40/02; G06Q 20/389

(57) ABSTRACT

An offer including an offered benefit is provided for transmission to each of a plurality of first users who meet criteria for being part of a group of first users. Each user of the first users is provided the offer and has an opportunity to accept the offer. When accepted, the first user who accepted the offer receives the offered benefit and releases information to the offeror.

### FIELD OF THE INVENTION

The invention relates generally to computer and digital security and more particularly to the use of cryptography and blockchain for uniquely securing identifiers.

### BACKGROUND

Historically, there were many disputes surrounding purchase and sale of goods. Before money, the accusation that the scale was inaccurate or that there was some mischief was commonplace. Once money became common, the argument was about what transpired, was payment made. Honest vendors kept ledgers on clay tablets that verified each payment. Honest purchasers would ensure that the ledger entry was made. Most disputes between ordinary people were resolved by leaving things as they were. Dishonest merchants got away with their dishonesty. From that, the adage, “Buyer Beware” was born.

With the advent of inexpensive paper, honest vendors began to offer their customers paper receipts. At first these were handwritten but later they were replaced by printed receipts. Today, these receipts are used by nearly all merchants as proof of a transaction. Receipts often indicate a product and a purchase price. Receipts also often indicate taxes levied and payment method/receipt.

Governments rely on the receipts for proof of expenses. Manufacturers rely on receipts as proof of purchase. Retailers rely on receipts for handling returns or upgrades. In the end, these small papers are often more important than they seem. That said, receipts have barely changed over the last hundred years and due to many reasons, are ill suited for the modern world.

It would be advantageous to overcome at least some problems with existing proof of transaction.

### SUMMARY OF EMBODIMENTS OF THE INVENTION

In accordance with an embodiment there is provided a method comprising: providing a first set of data stored in an electronically accessible form and stored in association with a first user; receiving by the first user an offer from a first offeror to provide access to specified data within the first set of data to a third-party in return for an offered benefit; accepting by the first user the offer; and in response to accepting by the first user permitting the third-party access to the specified data.

In some embodiments the first set of data is stored within a blockchain, data within the first set of data secured with a user private key associated with the first user.

In some embodiments wherein the first set of data is stored within the cloud, data within the first set of data secured with a user private key associated with the first user.

In some embodiments the first user is provided the offered benefit.

In some embodiments the offered benefit is held in escrow by an electronic system and wherein the electronic system releases the offered benefit when it has access to the specified data.

In some embodiments the offered benefit is a monetary benefit.

In some embodiments wherein upon accepting the offered benefit, a system of the first user retrieves first data secured with a private key associated with the first user and provides second data to the third-party.

In some embodiments the second data is watermarked for supporting identifying of the second data by the first user.

Some embodiments further comprise processing the offer by at least one of a broker and a system of the first user to determine if the offer is applicable to the first user; and when the offer is determined to apply to the first user providing the offer to the first user for review.

Some embodiments further comprise automatically processing the offer by at least one of a broker and a system of the first user to determine if the offer is an offer that is acceptable to the first user; and when the offer is determined to be acceptable to the first user automatically accepting the offer.

In some embodiments the second data is verifiable against the secured first data to determine its accuracy.

In accordance with an embodiment there is provided a method comprising: purchasing a first item; receiving a first receipt relating to the purchase; imaging the first receipt; generating at least a unique digital token associating elements of the purchase, the elements including the first item; and recording within a blockchain a record indicative of an event represented by the first receipt.

In accordance with an embodiment there is provided a method comprising: providing an offer to first users comprising: specifying an offered benefit, transmitting to each of the first users the offer comprising an indication of specified data to access in return for the offered benefit.

In some embodiments the offer comprises characteristics of each first user for receiving the offer and users are filtered based on the characteristics to determine the first users.

In accordance with an embodiment there is provided a method comprising: providing an offer to first users comprising: specifying an offered benefit, transmitting to each of the first users the offer comprising an indication of specified data to access in return for the offered benefit; providing a first set of data stored in an electronically accessible form and stored in association with a first user; receiving by the first user an offer to provide access to specified data within the first set of data to a third-party in return for the offered benefit; accepting by the first user the offer; and in response to accepting by the first user the offer, permitting the third-party access to the specified data.

In accordance with an embodiment there is provided a method comprising: providing a first asset token owned by a first user; transmitting to the first user an offer to permit a third-party access to token information associated with the asset token; and accepting by the first user the offer to permit access, thereby granting to the third-party access to the token information.

In accordance with an embodiment there is provided a method comprising: assembling a set of tokens associated with items including the first item into a composed asset token linked to all tokens within the set.

In accordance with an embodiment there is provided a method comprising: providing a product; generating a unique digital asset token uniquely associated with the product; commercially transacting in association with the product; entering details relating to the commercial transaction into a blockchain and in association with the unique digital asset token to form at least part of a digital ledger of commercial transactions relating to the product with the blockchain.

In accordance with an embodiment there is provided a method comprising: providing a first item; generating a unique digital asset token associated with the first item; generating a machine-readable code associated with the unique digital asset token; printing the machine-readable code; and affixing the machine-readable code to the first item.

In accordance with an embodiment there is provided a method comprising: providing a first item; generating a unique digital asset token associated with the first item; associating the unique digital asset token with a first individual; storing for the first individual identification information including contact data; and automatically retrieving the stored identification information and registering ownership of the first item with a first company.

In accordance with an embodiment there is provided a method comprising: providing a first item; generating a unique digital asset token associated with the first item; associating the unique digital asset token with a first owner; and monitoring network communication for an offer for sale of the first item.

In accordance with an embodiment there is provided a method comprising: providing a plurality of asset tokens, receipt tokens and event tokens; providing a search criteria; and retrieving tokens meeting the search criteria.

In accordance with an embodiment there is provided a method comprising: providing a first item; generating a unique digital asset token associated with the first item; associating the unique digital asset token with a first owner; transferring the first item to a second other owner; associating the unique digital asset token with the second other owner; and subsequent to transferring, searching by the first owner an owner of the unique digital asset token.

In accordance with an embodiment there is provided a method comprising: determining all digital asset tokens associated with products of a certain type; and transmitting via the blockchain to each digital asset token a message intended for an owner of said digital asset token.

In accordance with an embodiment there is provided a method comprising: determining all digital asset tokens associated with products of a certain type; for each of the determined digital asset tokens, determining contact data for at least one of a current and a previous owner of the digital asset token; and transmitting via the determined contact data, a message intended for at least one of a current and past owner of said digital asset token.

In accordance with an embodiment there is provided a method comprising: providing a first item; uniquely identifying the first item in reliance upon a repeatably identifiable process; generating a unique digital asset token associated with the first item and the repeatably identifiable process, the unique digital asset token indexed on a result of the repeatably identifiable process; and recording within a blockchain and associated with the unique digital asset token, data relating to the first item.

In accordance with an embodiment there is provided a method comprising: providing a unique identifier associated with an individual, the unique identifier for associating digital assets with the individual; retrieving digital tokens associated with physical assets that are associated with the individual by ownership; and providing a list of the associated physical assets and the retrieved digital tokens for use in insurance rate calculation.

In accordance with an embodiment there is provided a method comprising: providing a unique identifier associated with an individual, the unique identifier for associating digital assets with the individual; retrieving digital tokens associated with physical assets that are associated with the individual by ownership; and providing a list of the associated physical assets and the retrieved digital tokens for use in insurance claims adjustment.

In accordance with an embodiment there is provided a method comprising: providing a descriptor for a replacement item needing to be replaced; searching unique digital asset tokens for a unique digital asset token associated with an item that is identical or sufficiently identical to the replacement item to determine search results; and offering holders of unique digital asset tokens within the search results to purchase their digital asset tokens and the items associated therewith.

In accordance with an embodiment there is provided a method comprising; transmitting, via a wide area network, a request for insurance for a target item on a public marketplace for a first recently acquired asset by submitting the asset token and associated data for the target item; automatically generating by the insurer an insurance quote for the target item and transmitting the insurance quote via the wide area network.

In accordance with an embodiment there is provided a method comprising: transmitting, via a wide area network, a request for warranty for a target item on a public marketplace for a first recently acquired asset by submitting the asset token and associated data for the target item; and automatically generating by a provider a warranty quote for the target item and transmitting the warranty quote via the wide area network.

In accordance with an embodiment there is provided a method comprising: providing a first asset token owned by a first user; transmitting to the first user an offer to permit access to token information for a 3rd party for allowing access to token information directly on the distributed ledger; and accepting by the first user the offer to permit access, thereby granting to the 3rd party access to the token information.

In accordance with an embodiment there is provided a method comprising; retrieving via the blockchain, data relating to a first asset; and calculating loyalty program metrics based on the data and indicative of an asset ownership lifecycle.

In accordance with an embodiment there is provided a method comprising: retrieving a first asset tokens associated with a physical asset that is associated with a warranty claim; confirming ownership of the first asset token; and automatically providing a confirmation of ownership for each element of the warranty claim for claims adjustment.

In accordance with an embodiment there is provided a method comprising: retrieving a first asset token associated with physical assets that are associated with a warranty registration; and; confirming ownership of the first asset token; automatically providing a confirmation of ownership for each element of the warranty registration; and registering by a warranty provider, the warranty in association with the first asset token and its owner.

In accordance with an embodiment there is provided a method comprising: retrieving tokens relating to a same digital wallet; calculating spending patterns for the digital wallet; and using the calculated spending patterns to determine generalised spending information for groups of wallets.

In accordance with an embodiment there is provided a method comprising: retrieving tokens relating to a same digital wallet; and calculating a carbon footprint estimate for the digital wallet.

In accordance with an embodiment there is provided a method comprising: retrieving tokens relating to a same digital wallet; and calculating spending patterns for the digital wallet; and using the calculated spending patterns to determine messages to transmit to the digital wallet.

In accordance with an embodiment there is provided a method comprising: retrieving tokens relating to a same digital wallet; calculating asset values for the digital wallet, the asset values based on a current value of each asset in used condition; and reporting the asset value.

In some embodiments generating at least a unique digital token comprises: generating a receipt token associated with the first receipt; and generating a first asset token representing the first item and associated with the receipt token.

In some embodiments generating at least a unique digital token comprises: generating a receipt token associated with the first receipt; and generating a first asset token representing the first item and associated with the receipt token; and generating an event token associated with an event, the event token associating the purchase, the receipt, and the first item.

In some embodiments a single receipt token is associated with each of multiple reimbursement claims, the receipt token provided to each reimbursing entity, wherein each reimbursement claim is for a different portion of the receipt and wherein reimbursement claims in aggregate are limited to an amount of the receipt.

In some embodiments different tokes are associated with different individuals.

In some embodiments, access is temporary having a known end date and time.

In some embodiments access is restricted to predetermined data.

In some embodiments the first user remains anonymous.

In some embodiments the token information relates to an asset token for an asset that is declared lost.

In some embodiments the third party is a government or government agency.

In some embodiments the third party is a marketplace for offering an item associated with the first asset token for sale.

In some embodiments the third party is provided limited access to information, further information available in response to another transaction.

In some embodiments the first item is a permit and wherein the unique digital token comprises an asset token including permit details, the asset token transferred to a purchaser of the permit.

### BRIEF DESCRIPTION OF THE DRAWINGS

FIG. 1 is a simplified flow diagram of a purchase having a receipt associated therewith;

FIG. 2 is a simplified flow diagram of a purchase having a receipt associated therewith and used to form an asset token cryptographically recorded within a ledger;

FIG. 3 is a simplified flow diagram of an asset lifecycle having used to form event entries associated with an asset token cryptographically recorded within a ledger;

FIG. 4 illustrates the system in one embodiment of the present invention

FIG. 5 illustrate some components of a mobile application 100 in one embodiment of the invention

FIG. 6 illustrate some components an application backend 200 in one embodiment of the present invention.

FIG. 7 illustrates some components a distributed ledger 300 in one embodiment of the invention.

FIG. 8 illustrates some components of business application 400 in one embodiment of the invention.

FIG. 9 illustrates the token data model 301A in one embodiment of the invention.

FIG. 10 illustrates the asset token lifecycle 301B in one embodiment of the invention.

FIG. 11 illustrate the token privacy model 301C in one embodiment of the invention.

FIG. 12 illustrates a token registration 50 in one embodiment of the invention; and

FIG. 13 is a simplified flow diagram of a method of generating an insurance quote relying on an automated system and the distributed ledger.

FIG. 14 is a simplified architectural diagram illustrating a system wherein consumer data is shared as market insights.

FIG. 14B is a simplified flow diagram illustrating a method of entering and sharing consumer information from receipts.

FIG. 15 is a simplified flow diagram of a process for generating tokens for leasing a new car.

FIG. 16 is a simplified flow diagram of a method of sharing information including data therein for use in tracing information sharing.

FIG. 17 is a simplified flow diagram of a method of interactively negotiating for information sharing.

FIG. 18 is a simplified flow diagram wherein an insurance company makes an offer to users in order to access user information.

FIG. 19 is a simplified flow diagram wherein a user enters personal information and purchase information and is offered an offered benefit for sharing said information.

FIG. 20 are two flow diagrams for a process of replacing an item that has been lost or damaged.

FIG. 21 is a simplified flow diagram of a method of applying share-to-earn to research in the form of market research.

FIG. 22 is another simplified flow diagram applying share-to-earn to market research.

FIG. 23 is a simplified flow diagram of a generic market research framework wherein users can opt to share predetermined data for specific or general research purposes.

FIG. 24 is a simplified flow diagram for accessing market insights.

FIG. 25 is an architectural diagram of a share-to earn system.

FIG. 26 is a simplified flow diagram of a method of responding to business requests. Within a share-to-earn architecture.

### DETAILED DESCRIPTION

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

“Receipt” is a mechanism for capturing proof of transaction registering commercial exchange between parties such as a merchant and a consumer. Receipts represents any type of proof of transaction like physical or digital based receipt, contracts, agreement, laws, permits, etc.

“Item” is anything that can be owned, possessed, or allocated to an individual. Items include assets, but also include other items whether financially valuable or not. Items includes digital items and physical items and contractual items. For example, rights encoded in a document or contract (a permit, for example) are an item.

“Asset” is an item of value that is identifiable and includes digital and non-digital assets such as a guitar, a permit, a computer, a work of art, etc. An asset is any resource owned or controlled by an individual—a consumer, a business, or an economic entity. An asset is anything (tangible or intangible) that can be used to produce positive economic value.

“Blockchain” is a technology wherein data is encoded in a cryptographic format to allow for verification of encoded entries authenticity and time of encoding.

“Receipt” is a representation of a proof of transaction and, more typically, a receipt is a proof of transaction provided at point of sale.

“Digital Token” or “Token” is a unique digital asset that is verifiable, examples of tokens include receipt token, asset token and event token. Digital tokens are also used to represent value in the case of Bitcoin, for example.

“Asset Token” is an immutable representation as a digital token relating directly to an asset or an item. The term asset is used to refer to any asset, a physical asset, a contractual asset, or a digital asset. The term item is used to refer to any item, a physical item, a contractual item, or a digital item.

“Event Token” is an immutable representation of an event associated with an asset/item. The term event is used in a large sense where an event is any moment in time captured that may apply to an asset/item. The event token may comprise an event category (e.g., tag, manufacture, own, transfer, declare lost, declare found, found, repair, maintenance, declare, destroyed, declare recycled, refurbish, move location, etc.).

“Receipt token” is an immutable representation of the digitalization of a receipt. The term receipt is used in to represent any type of proof of transaction and more typically proof of transaction provided at point of sale.

“Tokenised” refers to the process of representing something else with a token. For example, an asset token is not the asset itself and instead the asset is tokenized.

“Ledger” A ledger is a set of entries reflecting account transactions that are recorded or stored for tracking events relating to the account.

“Distributed ledger” also called a “shared ledger” or “distributed ledger technology” (DLT) is a consensus of replicated, shared, and synchronized digital data geographically spread across multiple sites, countries, or institutions.

“Permissioned based distributed ledger” is a distributed ledger wherein only approved entities host a node to access or to validate transactions.

“Know your customer” standard refers to any of a number of legal requirements to verify customer information such as FINRA Know Your Customer Rule 2009 where it is a requirement to know and keep records on the essential facts of each customer, as well as identify each person who has authority to act on the customer's behalf

“Mobile application” includes any type of application available on devices like personal computers, smart phones, tablets, and other devices that a consumer or employee of participating business can use. The type of application includes but is not limited to the native applications for execution on mobile phones and tablets, applications for execution via the internet and a web browser, custom applications, html5 based applications available on the application stores for devices and also HTML based applications. In some embodiments, the mobile application can access a camera and microphone available on a device to capture information with sound or images, QR codes, UPC codes, video, voice, or any other type of content that can be captured by the device.

“Marketplace” refers to a virtual business transaction location or process.

“Participating business” represent any type of organization with intent to participate (in some embodiment of the invention) to create and exchange tokens or information about tokens.

“Smart contract” is data for execution that according to a transaction protocol automatically executes to control or document legally relevant events and actions according to the terms of a contract or an agreement.

“Value chain” relates to an element of a system that, as a whole, provides value. The element is a link in the value chain, and it provides some value or some precursor to value. For example, data extracting through data mining can form an important link in a value chain. The system, may include subsystems each with input values, transformation processes and output values. Input values, transformation processes, and output values involve the acquisition and consumption of resources real or virtual—data, work, money, labour, materials, equipment, buildings, land, intellectual property, administration, and management to list a few.

Receipts are a mechanism for verifying a transaction that registers a commercial exchange between parties such as a merchant and a consumer. Receipts represent any type of proof of transaction such as a paper document that is provided by a vendor to a purchaser or a pdf file transmitted from a vendor to a purchaser. In some embodiments receipts are or include contracts, contract terms, agreements, legal disclaimers or claims, permits, etc. While a merchant gains value from each receipt as an accounting entry, receipts today are more useful than merely for accounting. Through its point-of-sale database, a merchant also uses receipts for inventory control, scheduling, and other business intelligence. With emailed or personalised receipts, the merchant also gains consumer behavioural information that is useful in marketing, store layout, staffing, etc.

Recently, accounting software has begun scanning receipts to enter financial details into bookkeeping software. This simplifies accounting for businesses and for home businesses. This allows an image of a receipt to be stored with its accounting entries in a bookkeeping system for business. Unfortunately, a consumer doesn't have an easy way to capture non-monetary data from receipts for other uses. For example, a user may wish to create a database across various other entities with which the consumer is transacting. The information captured by the merchant and by a payment processor remains in their respective possession with no flow-through with the Merchant's line items information to the payment systems; only the aggregated view of the consumer transactions with the Merchant gets captured by the payment system. Further, the data on the receipt is difficult to track and manage when a single receipt reflects multiple purchases. State of the art payment systems provide consumers with categorical spending—food or office or gasoline—when using their payment system. When a consumer is interested in managing assets or events relating to said assets, manual work needs to be performed to document assets, attach physical or digital receipts, and manually record events. For example, manual copies are made of a receipt that are then affixed to appliances so that warranty information is affixed to each appliance in case of later need. Further, there is no automated process to notify the consumer on important event like recalls, dangers, warranty end date, planned maintenance, etc. The manufacturers interacting with an asset owner is also very disparate and may involve individuals registering assets on disparate systems of registration. The lack of proper integration of these systems creates an inefficiency in the marketplace; unfortunately, automating these processes risks violating people's privacy as some customers may want to remain anonymous to the manufacturer of their assets.

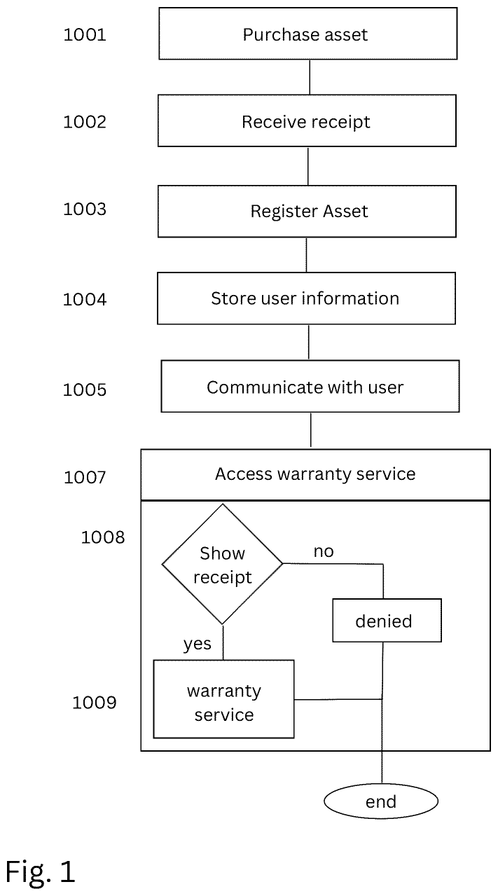

Referring to FIG. 1, shown is a simplified flow diagram relating to purchasing a new asset. Here, a user purchases a new asset at 1001 and receives the new asset and a receipt at 1002. The user then has an option to register the new asset with the manufacturer at 1003. If the user does so, the user's information is stored by the manufacturer in association with the asset at 1004 and the manufacturer can communicate with the user at 1005. If the user chooses to not register the new asset, then the manufacturer knows that the new asset was sold and may even know where it was sold—by which store—but the manufacturer cannot contact the purchaser. If the user wishes to access warranty services at 1007 for the new asset, the user needs to show the receipt at 1008, proving purchase and purchase date, in order to get warranty service at 1009. Thus, the receipt must be stored by the user securely for rapid retrieval in the case of a warranty issue. If the user disposes of their receipt, then access to warranty service may be impossible. Thus, registering with the manufacturer is the safest approach to preserving the new asset at the cost of personal privacy.

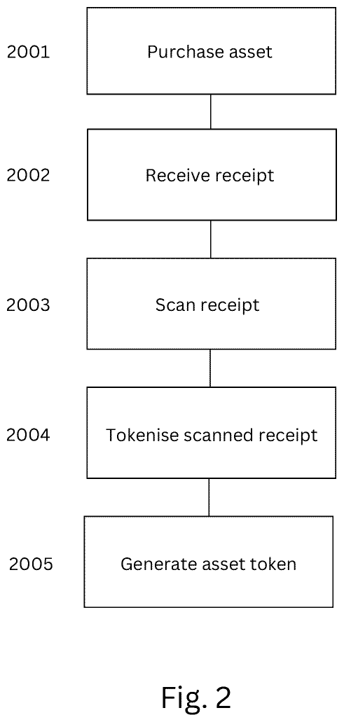

Referring to FIG. 2, shown is a simplified flow diagram of a method according to an embodiment. Here, a user purchases a new asset at 2001 and receives the new asset and a receipt at 2002. The user then scans the receipt at 2003 and the scanned receipt is tokenised at 2004 with the token cryptographically secured by the user's private key within the blockchain. Thus, whoever has the private key can prove ownership of the receipt but need not be identified to the manufacturer. A second token is generated 2005 associated with the new asset and cryptographically secured by the user's private key within the blockchain. This associates the new asset with the user separately from the transaction indicated by the receipt. Should the user sell the asset, the asset token can be transferred to the new owner via another event or absent another event. Thus, separation of event and asset allows a user to see all their receipts—buy and sell—and all their assets without having to transfer receipts that reflect events.

Advantageously, a user can review all their assets by reviewing their tokens. For example, a company can review what computers it owns and pull up serial numbers, etc. by reviewing asset tokens. When a computer dies, an event that the computer was repaired or was disposed of can be entered for the asset. When a computer is sold, an event showing that the asset was sold can be entered. The manufacturer knows that a new asset was sold and may even know where it was sold—by which store—but the manufacturer cannot contact the purchaser directly. However, the manufacturer could send a note via the blockchain to the asset token associated with the asset. If the user wishes to access messages of this nature, they do; otherwise, those messages remain undelivered to the user. If the user wishes to access warranty services for the new asset, the user can easily retrieve the receipt token associated with purchasing the asset, proving purchase and purchase date, in order to get warranty service. Thus, the receipt is stored within the blockchain for rapid or automated retrieval in the case of a warranty issue. Thus, registering with the manufacturer is rendered more optional at the cost of personal privacy.

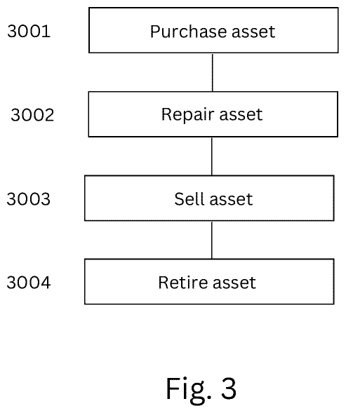

Referring to FIG. 3, shown is a simplified flow diagram of an asset lifecycle. At 3001, the asset is purchased. At 3002, the asset is repaired. At 3003, the asset is sold to a second-hand user. At 3004, the asset is retired, disposed of permanently. Each event is associated with the same asset and reflects a separate event in the lifecycle of the asset. Some assets get rebuilt, repaired, and so forth over many decades. For example, a piano might get tuned four times a year and restrung every 5 years and rebuilt every 50 years. Each event and each repair are recordable within the blockchain associated with the asset, the piano. If a user then wants to sell the piano, its history is easily retrievable and verifiable within the blockchain. More complex assets are easily organised into hierarchies such that reviewing maintenance history on long lived assets is simplified.

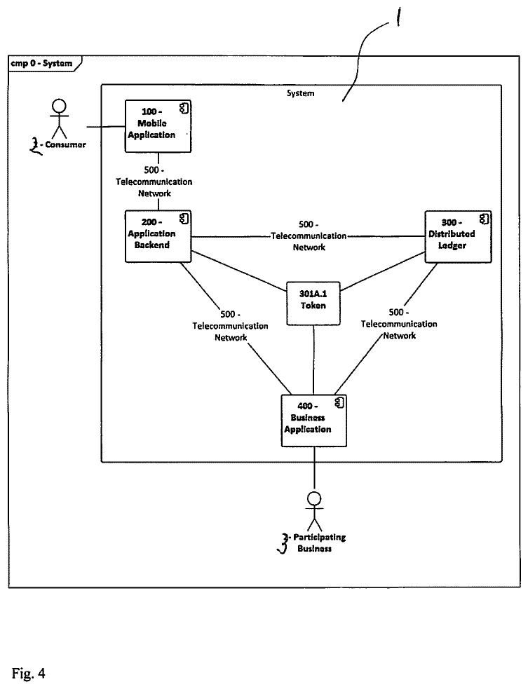

FIG. 4 shows a simplified block diagram of a system including a marketplace where individuals interact with system 1. In some embodiments, the system 1 includes stakeholders, for example those that form part of the marketplace and that interact with the system 1. Stakeholders in some embodiments include consumer 2 in the form of a user and a participating business 3.

The system 1 includes a mobile application 100, an application backend 200, a distributed ledger 300, a plurality of tokens shown by example of a single token 301A.1 and business application 400. The mobile application 100, the application backend 200, the distributed ledger 300, and the business application 400 are communicatively coupled via telecommunication network 500. The telecommunication network 500 comprises any suitable communication technology forming a network capable of transmitting information between entities and relies upon a suitable communication protocol.

In the present embodiment, components within the mobile application 100, application backend 200, distributed ledger 300, and business application 400 communicate through communication network 500. For example, a component of the application backend 200 in the form of database 202 is operated within the cloud, from a different physical location than the rest of the application backend 200 components. The consumer 1 operates the mobile application 100 on a mobile device belonging to the user. Alternatively, some operations of the mobile application 100 are performed absent user involvement. The mobile application 100 is configured to communicate with the application backend 200 in such a way that the application backend 200 recognizes the mobile application authentication and authorize interactions; for example, the mobile device requires user authentication prior to issuing a request of the application backend 200 and transmits an authentication code to the application backend 200 with a request in order to authenticate the device and the request. In some embodiments, the user has access to the system via numerous devices in the form of a mobile communication device, a computer, and/or a browser window. Examples of user authentication information include passwords; biometric samples in the form of voice, fingerprint, iris, face, signature, and/or hand geometry; and physical devices such as cold storage wallets, key cards, and/or secure keys. In some embodiments a combination of user authentication information is relied upon.

Referring to FIG. 4, the consumer 2 need not be a unique individual. In fact, users optionally have multiple persona within the system, representative for example of a personal account, a business account, and/or a single purpose account. Each account is associated with one or more digital identity that is uniquely identifiable to the system 1.

Typically, the application backend 200, executes in a cloud based operating environment. “Cloud based” indicates that the environment is executed in an environment that is not executed at a specific fixed deterministic location. Of course, the application backend 200 is also executable on a predetermined server or at a predetermined electronic address. Typically, the distributed ledger 300, executes in a cloud based operating environment. Of course, the distributed ledger 300 is also executable on a predetermined server or at a predetermined electronic address. Though the term distributed ledger typically refers to data stored forming a ledger, here the distributed ledger 300 refers to the data and executable code for reading and writing to the distributed ledger data. Typically, the business application 400, executes in a cloud based operating environment. Of course, the business application 400 is also executable on a predetermined server or at a predetermined electronic address. The business application 400, interacts with other systems or users via an interface; for example, the interface is automated and standardised for common application. Alternatively, the application involves a user interface for validating transactions and for accepting user input data to the system. Advantageously, each of the application backend 200, the distributed ledger 300 and the business application 400 share a same representation of the token 301A.1 such that each relies upon a same asset token format and a same receipt token format. By relying on a same token format, the system facilitates token use and token content generation. Alternatively, different token forms and content are supported wherein the system 0 automatically detects a token format and reads/writes the token 301A.1 content automatically to a record for use by the system 0. Such a multi format token allows for merging of different systems including system 0 into a single functioning marketplace.

When a plurality of token access modules is implemented for converting token data into suitable record formats, the system 0 sees tokens with different formats as identical once read. This allows the system 0 to be token form independent so long as the tokens are associated with similar or analogous data/information.

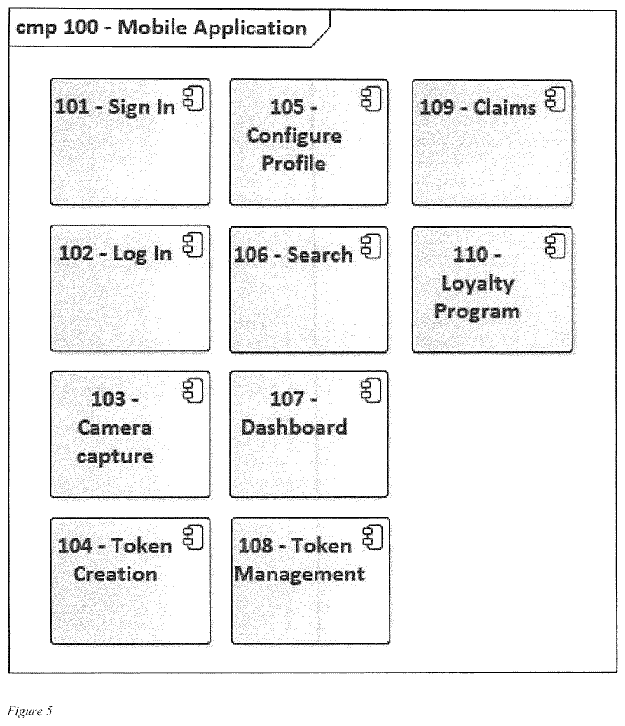

FIG. 5 illustrate some components of the mobile application 100. The mobile application 100 includes a sign in component 101, a log in component 102, a camera capture component 103, a token creation component 104, a configure profile component 105, a search component 106, a dashboard component 107, a token management component 108, a claims component 109. These components are integrated within the mobile application. Alternatively, these components form part of functions or libraries already available in the mobile device environment. Further alternatively, some of these components are implemented within the mobile application environment and others are implemented at least partially within the cloud.

The sign in component 101 is configured to automate registration of users within the mobile application 100. In some embodiments, know your client (KYC) is performed to meet local legal standards. In other applications, financial transactions are separated from the mobile application allowing for anonymity within the mobile application. For example, when a user uses the mobile application for tracking their assets and asset related events, there is no need for KYC. In contrast, when the user links their bank account to the mobile application 100, KYC may be required by law in some jurisdictions. Further, should the mobile application 100 allow for financial transactions to be processed, KYC is likely required. In some embodiments, the mobile application 100 performs KYC regardless and stores the data locally to the mobile application for release when a transaction is of a nature requiring the data. This KYC information is typically gathered by the sign in component 101. In some applications KYC dependent transactions use a separate private key from private transactions so a user is automatically provided two accounts, one trackable and the other private. When the accounts are not linked, the user's privacy is maintainable for private information.

Once a user is signed in, they have an “account” within the system 1, the log in component 102 then allows the user to authenticate to the mobile application 100 to access consumer data and consumer associated data. In some embodiments, the log in component 102 executes each time a user wishes to release private data to another user or to another system. For example, before releasing KYC data to an insurance company, a user is prompted to authenticate to the mobile application 100 via the log in component 102. Alternatively, the user is prompted to authenticate when authentication has not been performed over a certain interval of time. The log in component 102 acts to preserve security for private information or data by requiring user authentication to verify user intent. Some data written to the blockchain is public in nature. Other data is obfuscated and requires data from the user to be accessed. This obfuscated data is typically only accessible when a user authenticates to the log in component 102 and chooses to read the obfuscated data or share it.

The camera capture component 103, allows the mobile application 100 to use a camera integrated with the mobile device to capture image or video data and more specifically to initiate creation of receipt token 301A.2 by imaging a receipt and performing text extraction to read contents of the receipt that are within the image. Once extracted, text is analysed to determine receipt date, seller, products sold, price of each product and quantities, and payment method. Further data such as tax IDs are also extracted for inclusion in association with the receipt token 301A.2. In some embodiments, receipts include codes in the form of QR Codes, UPC Codes or other machine-readable codes. This allows for retrieval of receipt content from a database based on a machine-readable code. In some embodiments, assets are provided codes in the form of QR Codes, UPC Codes or other machine-readable codes. This allows assets to be tokenised, creation of asset tokens 301A.3 by scanning a code and retrieving asset specific data from a database; for example, asset specific data includes model number. Alternatively, asset specific information comprises serial number, manufacture date, and version numbering.

The token creation component 104 is for token creation. The token creation component creates receipt tokens 301A.2 for receipts, asset tokens 301A.3 associated with assets, and event tokens associated with events that are associated with assets. Examples of events include repairs, destruction, sale, and disposal. In some embodiments, the token creation component is for creating tokens in any of a plurality of formats. Once created, tokens are encoded within a blockchain such that their history and ownership is verifiably stored in a verifiable and typically immutable form. Alternatively, tokens are stored in a local database allowing search and retrieval thereof.

The configure profile component 105 provides options for configuring a user profile. The user profile is for rendering use of the system 1 more user friendly. For example, user profile options often include user privacy settings, user security settings, notification settings, account information, etc. In some embodiments, user settings affect profile choices. For example, when user private information is stored, security is often required. Similarly, when user profile settings allow access to regulated industries such as bank accounts, security settings are often limited to maintain bank security. In some embodiments, user settings establish a level of security for interactions allowing users to filter potential interactions based on a security of their account or that of another or even based on security of data relied upon.

The search component 106 provides search capabilities to the user for retrieving tokens and other data from the distributed ledger 300. Of course, some data, even when retrieved, is obfuscated and requires permission to be viewed in plain text. Other data links to an index instead of information, for example, the asset belongs to user 123456789, which is not identifying of the user unless user 123456789 chooses to share personal information. However, communication with user 123456789 remains possible through the ledger, should user 123456789 have profile settings allowing for notifications via the ledger. When KYC is performed, police and financial institutions can resolve the user ID through a formal request to a party having KYC information for that index.

The dashboard component 107 presents user data in the form of token data in a structured way. The data facilitates the review, management, use and exploration of data and is useful for providing insights into a user's assets, spending, and events relating to their tokens. In some embodiments the dashboard component 107 allows for user annotation either within the ledger or privately. In some embodiments, the dashboard provides insights in the form of graphs, statistics, predictions, or market data associated with tokens of the user. Insight may include, and not be limited to, historical data, time series, trends, predictions, and carbon footprint; the dashboard optionally relies on external predictive or analytics or models to provide insights. These external processes are typically selectable by the user.

The token management component 108 provides management processes for making changes to tokens 301A.1 and their associated information, after their registration. The management of tokens does not overwrite existing data but instead adds new data to the ledger such that tokens and their histories are reliably verifiable. A change in ownership of a token is reflected in a transfer to a different cryptographic key—a different wallet. A change in associated data often involves writing new data to the ledger associated with one or more token. Examples of changes supported by the token management component 108 include token 301A.1 information update, token 301A.1 permission changes, asset token 301A.3 ownership transfers, event token update, and receipt token allocation. The management of tokens is sometimes automated through a smart contract 302 to maintain data relating a history of a change and causes of said change in the distributed ledger 300.

The claims component 109 allows a user to assemble tokens into a grouping, for example as part of a claim or as part of a transaction. A claim represents a need for a consumer to support verification from a 3^{rd} party of one or more declarations that are captured in tokens 301A.1 and their associated information stored within the distributed ledger 300. For example, a claim for insurance involves assembling receipt tokens 301A.2, related to a specific location in case of damage to a property. In another example, a claim for tax exemption involves assembling all receipt tokens 301A.2 for a specific asset token 301A.3 like a rental property renovation. As yet another example, in selling a collection or a business, the claim provides evidence relating to underlying assets being transferred along with related information stored in the distributed ledger 300. The claim is then transferable as a digital file report (e.g., adobe .pdf format) or as an access code (e.g., QR code) for a 3^{rd} party to access and verify all claim digital material in the distributed ledger 300. This can simplify a transaction and also simplify dispute resolution should a dispute arise. In another example, if a business chooses to deduct an expense on a receipt against the business income, the tax authority can register that event against the receipt token or in the case of depreciation against the asset itself. This prevents a same receipt from being deducted multiple times and simplifies depreciation organization and calculations and audits. Allowing third parties to include data in the distributed ledger 300 is beneficial when those parties do so in their authoritative capacity. A lien is registrable against an asset and then can be recorded associated with the asset token, damage repair can be recorded against an asset token even if the owner of the asset chooses not to record the event, etc.

The loyalty program component 410 offers the user 2 an interface to one or more loyalty program 410 offerings based on tokens 301A.1. For example, a vendor offers a loyalty discount based on receipt tokens from the vendor. An airline offers flight bonuses based on flight event tokens associated with a user. In the case of flights, the user need not be the traveler, but instead could be a business or a charity. In some embodiments, loyalty programs analyze distributed ledger data to find suitable users to whom they wish to make offers. For example, a total receipt volume is analyzed for each user. In another example, users are analyzed to find those with more than two cars. In yet another example, users are offered a loyalty reward because of their assets, they collect stamps, or because of their spending, they purchase a lot of kitchen appliances. Thus, loyalty programs can be found and joined by the user beforehand, or users can be notified based on their tokens and associated data. Users may be informed of offers through the blockchain thus retaining their anonymity until such time as they share private information to join the loyalty program, when required.

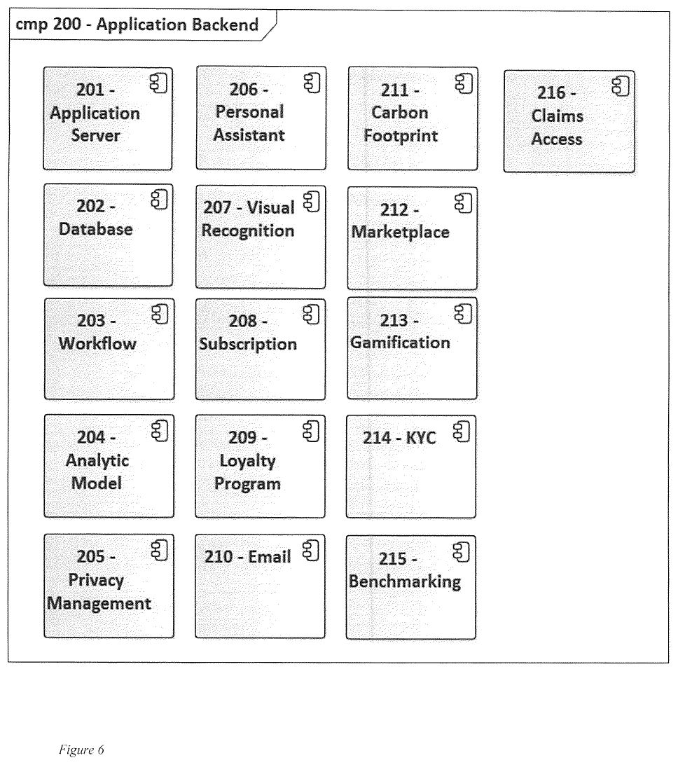

FIG. 6 is a simplified block diagram illustrating some components of an implementation of application backend 200. Application server component 201 offers secured access to functions in the application backend 200. Database component 202 is configured to maintain information relating to the mobile application 100 and other information that supports the mobile application 100 and the application backend 200. Typically, the database component 202 is incorporated within the application server component 201, but in some embodiments, the database component 202 is other than incorporated therein. In some embodiments, the database component 202 is distributed.

Workflow component 203 supports some or all workflows between the mobile application 100 and the application backend 200, between the application backend 200 and the distributed ledger 300, and between the application backend 200 and business application 400. In essence, the workflow component 203 allows for requests to be distributed appropriately for execution on potentially disparate systems. The workflow component 203 also facilitates support for multiple standards and multiple token formats. An analytic model component 204 exposes analytic models to the mobile application 100 for the user and to the application backend 200 and business application 400, potentially for third-party use. The analytics model component 204 relies on analytic models such as predictive models, statistical models, anonymized data models, and aggregate data reporting. In some embodiments, the analytic model component 204 forms part of the workflow component 203 providing it access to disparate data within disparate storage.

Privacy Management component 205 supports management of token privacy model 301C. Token privacy models often include a global privacy structure with personal—user profile—privacy settings overlayed thereupon. This allows for privacy protection in general and privacy customization in specific ways. Preferably, models operate only on a restricted privacy setting relating to the global privacy framework that is more restrictive. That said, one model may report on privacy settings to help in business intelligence gathering by informing a business of a breakdown in users who want more or less privacy.

Personal assistant component 206 supports interactions and notifications between the application backend 200 and the user 2 using the mobile application 100. The personal assistant component 206 automatically responds to information requests based on user profile data. Further, the personal assistant component 206 also retrieves notifications for the user. In some embodiments, the user can provide the personal assistant component with tasks to monitor and execute. For example, the personal assistant component 206 is requested to look for a specific asset, a 1964 Gibson Songbird Guitar in mint original condition and to enter into a contract to purchase the asset at or below a known price. The personal assistant component then searches asset tokens for assets meeting the identified criteria and waits for one to be for sale at or below the stated price. When that happens, the personal assistant component 206 enters into a digital contract to purchase said asset. Due diligence follows and if the asset is as described, money deposited within the digital contract is transferred to the seller. In some embodiments, digital personal assistant components compete allowing a seller to achieve a highest reasonable price for an asset.

Visual recognition component 207 recognises specific information within images and either automatically enters it into the ledger or provides a recommendation to the mobile application 100 such as the receipt information is as follows: please confirm. Sometimes, a user using mobile application 100 customises the data, other times, the data is corrected. Yet other times the data is accepted as correct. Sometimes a user connects the data with other data manually, for example a specific asset token including a serial number is connected to a receipt token, where the receipt does not specify the serial number. In some embodiments, the image itself is stored within the distributed ledger to verify the data should verification be needed.

A subscription component 208 supports subscriptions. Subscriptions include warranties, extended warranties, benefits with warranties such as roadside assistance, paid subscriptions, and subscriptions to programs such as loyalty programs. Subscriptions includes digital subscriptions and other subscriptions. In some embodiments, some forms of insurance or benefits are stored as subscriptions allowing a user to register expenses against their subscription and to review subscription/benefits remaining. A specific subscription is a loyalty program and for that a separate component is implemented in some embodiments. A loyalty program component 209 manages interactions, information, and privacy between a consumer application 100 and loyalty program 410.

Email component 210 provides a communication channel between the application backend 200 and the user 2. The communication channel typically involves multiple communication methods such as messaging, a message board, email, text, etc. The email component in some embodiments does not support email instead supporting other communication channels. Optionally, the email component supports a dedicated communication path to the mobile application 100.

Carbon footprint component 211 calculates a carbon footprint of a consumer 2, of a business, or of an asset or purchase. The carbon footprint component relies upon formulas to apply carbon footprint values to asset tokens 301A.3 and their owners. In some embodiments, multiple formulas for calculating carbon footprints are supported with a carbon footprint and its formula being reported. This allows user 2 to calculate their carbon footprint for a purpose with a formula that supports their intended purpose. For example, if carbon footprint evaluation is being calculated for offset credits, a formula approved by the offset credit provider is used.

Marketplace component 212 manages marketplace aspects of exchanges of assets represented by asset tokens 301A.3. Once an exchange is completed. The token management component 108 is provided information for updating the distributed ledger 300. The marketplace component acts to support transactions within a digital marketplace and then relies on other components to record the transactions or to form contracts for enforcing the transactions.

Gamification component 213 may be configured to manage gamification elements to the mobile application 100 for incentivizing the user 2, to participate with at least an aspect of the mobile application 100. For example, an insurance company may gamify the process of asset tokenization to ensure that a customer's asset tokens are up to date. A loyalty program may gamify their data collection and rewards to increase their perceived value in the eyes of the users. The gamification component 213 supports different aspects of gamification for increasing user motivation to engage with service providers, and more particularly with the service providers they are engaged with.

Know Your Customer (KYC) component 214, manages a level of authentication for the user 2, using the mobile application 100. It also manages information sharing and permissions for those seeking information form the mobile application 100 and relating to user 2. Though KYC may be performed with the insurance company, for example, that does not mean that the user 2 wants their personal information shared amongst all merchants.

Benchmarking component 215 provides benchmarking capabilities across a consumer base in relation to each type of token. The benchmarking is often different for different tokens. For asset tokens, benchmarking can generalize a duration of ownership of an asset token category. Categories could be broad such as guitars or more specific such as 2008 Taylor guitars. Benchmarking gathers and assesses anonymous benchmark data for users and vendors alike. For example, time to disposal of an asset class is of interest to purchasers. A coffee grinder that breaks and is typically thrown out in a year is less valuable than one that lasts 3 years or five years. A machine that needs maintenance each month may be less valuable than one that only needs maintenance every few years. Benchmarking data is valuable to consumers. Similarly, other benchmarks are valuable to manufacturers and to vendors.

A claims access component 216 provides access to specific fields associated with specific tokens or groups of tokens for specific duration to an identified 3^{rd} party. This allows for due diligence based on restricted access and automatically revokes access when the time expires. In other embodiments, revocation of access involves the user 2 canceling or ending the claim. Claim access component 216, in some embodiments, allows for annotation of the tokens and data associated therewith allowing the tax authority to add notes to the distributed ledger or allowing appraisers to add notes in relation to asset tokens.

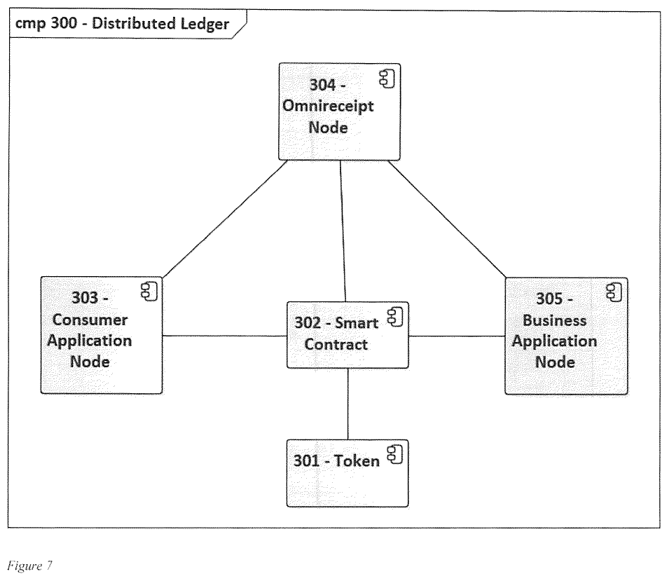

FIG. 7 illustrates some components of the distributed ledger 300 in accordance with an embodiment. Token component 301 is a process for implementation of all tokens—token 301A.1, receipt token 301A.2, asset token 301A.3 and event token 301A.4. Smart contract component 302 may be configured to implement all smart contracts that manage registrations and updates of tokens 301A.1 in the distributed ledger and associated ledger entries.

Mobile application node 303 virtualises the mobile application 100 interacting with the distributed ledger 300 using smart contract 302 to register and update tokens 301A.1. By virtualizing the connection between mobile application 100 and distributed ledger 300, support for other tokens and other standards is implementable within the virtualized layer. This allows the distributed system to be modified and expanded and to support multiple versions of the mobile application 100. Omnireceipt node 304 represents and virtualises a node where all tokens 301A.1 are registered. Business application node 305 supports a business application 400 interacting with the distributed ledger 300, for example relying on smart contract 302 to register and update tokens 301A.1. In some embodiments, use of business application node 305 allows for security and privacy enforcement through the additional layer.

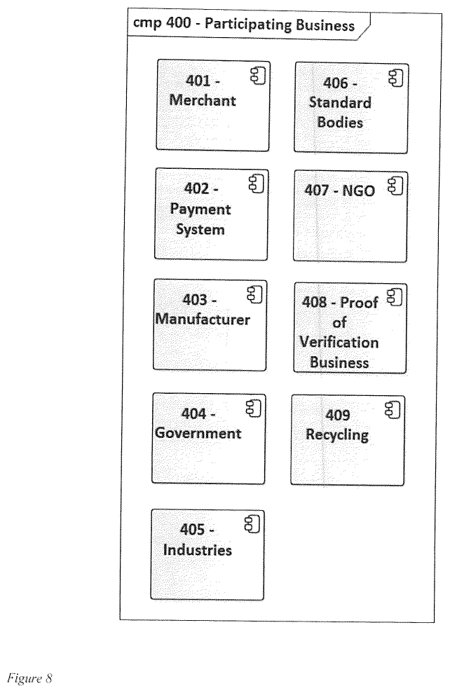

FIG. 8 illustrates some components of an embodiment of business application 400. Component merchant 401 enables merchants to create receipt tokens 301A.2, asset tokens 301A.3 and event tokens 301A.3 digitally and assign them to users or other participating entities. Effectively, this will bypass printing of paper receipts by generating digital receipts and tokens associated therewith. Further, asset tokens 301A.3 include or are associable by a manufacturer 403 with manufacturing information so that the manufacturing information is reviewable later in time. The digital receipts are also recordable in the distributed ledger 300 as officially and verifiably coming from a vendor. The digital asset token is verifiable as being provided by a manufacturer. Component payment system 402 enables a payment system to create a receipt token 301A.2 for a consumer. The receipt token is verifiably provided by a vendor to the consumer. In some embodiments, Component payment system 402 enables smart contracts for actualizing payment and exchange of goods. In those embodiments, payment, asset, vendor, etc. are all automatically added to the distributed ledger 300 upon transaction completion. Component government 404 enables officials and governments to generate tokens 301A.1 to represent permits, approvals, releases, licenses, etc. Thus, government documents that have value are registerable on the distributed ledger 300 in association with a user and with an asset or a receipt. Attaching government documents to assets is advantageous as it allows value accrued through permitting, for example, to be associated with and stored in association with a token for the physical asset.

Industry value chain 405 represents certain industry interests in processes facilitated by the distributed ledger and/or information contained within the distributed ledger or elsewhere in the blockchain. A commercial approach to the industry value chain 405 provides to industry insights related to their business, the tokens involved, and potential monetization.

A standard bodies component 406 allows for standard definitions and standard specifications to be registered as tokens 301A.1 and be linked to other tokens via smart contracts 302 or confirming verified compliance. The links between compliance tokens and other tokens are useful for reducing cost of verification and cost of networking of current compliance systems and methods. Further, it would link within the distributed ledger 300 the actual laboratory and test results that resulted in the verification being recorded. A component NGO 407 manages donations of unused assets, approvals or referrals from non-governmental bodies and other associations. For example, an NGO devoted to ending international poverty might record in the distributed ledger and associated with a company that the company has met its highest level of support for the project. Further, a component NGO 407 allows the recordation of projects and progress within the distributed ledger in association with users, companies, governments, and so forth.

A component proof of verification business 408 automates claims processing by automatically verifying information and claims that can be automated, thereby reducing cost of verification. For example, an accounting firm could configure the component proof of verification business 408 to automate some tax calculations based on distributed ledger access for a business or an individual to automate tax claims and audits and risk assessment for the user 2 or a participating business.

A component recycling 409 manages rebuilding and refurbishing of assets where the asset token 301A.3 is declared recycled so the asset token 301A.3 history documents multiple cycles of recycling and what is involved. In some embodiments, the component recycling 409 affects results of the carbon footprint component 211.

The component loyalty program 410 virtualises and manages the interactions between a loyalty program and the mobile application 100.

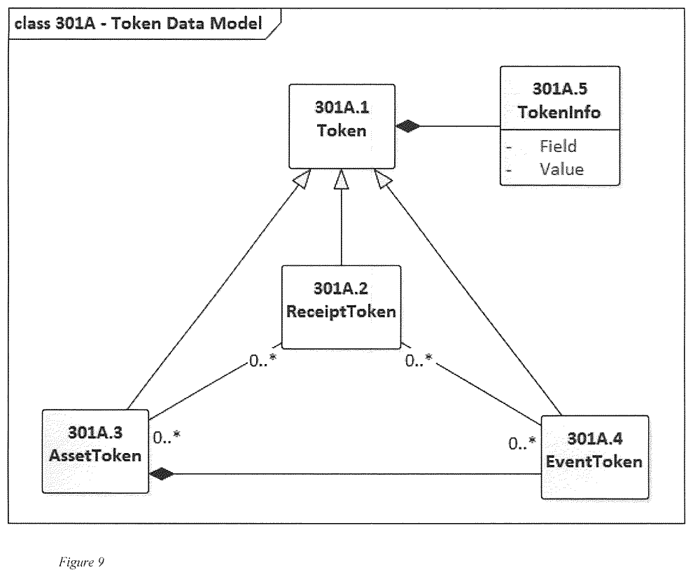

FIG. 9 illustrates the token data model as a UML class diagram.

The data model may contain the class Token. The Token class 301A.1 is the abstract class of all tokens. A Token is composed of zero to many TokenInfo 301A.5 instances. ReceiptToken class 301A.2 represents a token for any proof of transaction in the form of a purchase (e.g., receipt, contract, permit, etc.). A ReceiptToken is linked to zero or more AssetTokens. A ReceiptToken is also linked to zero or more different EventTokens 301A.4. AssetToken class 301A.3 virtualises any asset (physical or digital). The AssetToken is linked to zero or more different ReceiptTokens and EventTokens 301A.4. EventToken 301A.4 represent an event in relation to one asset (e.g., create, transfer, repair, relocate, etc.). An EventToken is linked to zero or more ReceiptTokens.

The TokenInfo class 301A.5 holds a field and value pair of any type of field and value providing for flexibility.

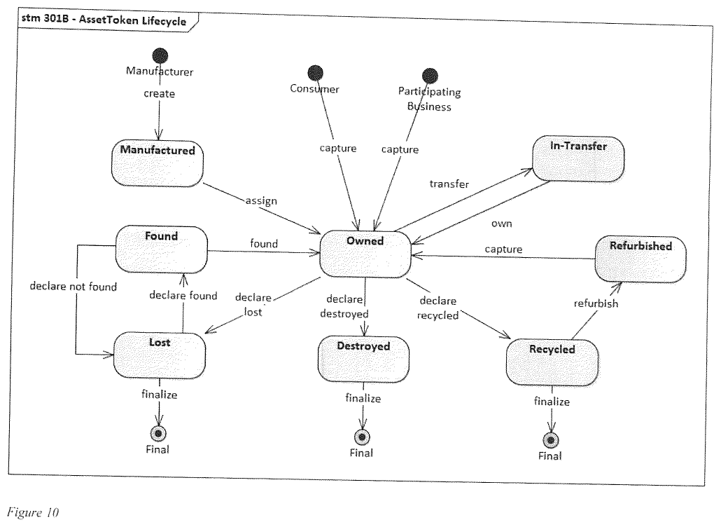

FIG. 10 illustrates an asset token lifecycle 301B as a state machine diagram. Each change to the lifecycle is processed by a smart contract 302 and/or a registered EventToken 301A.4 linked to the AssetToken 301A.3.

The state machine shown contains a starting point called “Manufacturer.” The “Manufacturer” starting point represents a situation where a manufacturer initiates the creation of an AssetToken as a mean to register a token for a manufactured product. The “Manufacturer” initial state of the state machine accepts the event “create” where the manufacturer creates a new AssetToken to register a manufactured product token. Once the “create” event is fully processed, the state machine state becomes “Manufactured.”

The state machine contains another starting point called “Consumer.” The “Consumer” starting point represents the situation where a consumer creates a new AssetToken to register a newly purchased asset, whether the asset is new or second-hand.

The “Consumer” initial state of the state machine accepts the event “capture” where the consumer creates a new AssetToken by capturing information on a newly acquired asset and creates a token. Once the “capture” event is fully processed, the state machine state becomes “Owned.”

The state machine also contains a starting point called “Participating Business.” The “Participating Business” starting point represents the situation where a participating business creates a new AssetToken to register a newly purchased asset.

The “Participating Business” initial state of the state machine accepts the event “capture” where the participating business creates a new AssetToken by capturing the information on a newly purchase asset to create the token. Once the “capture” event is fully processed, the state machine state becomes “Owned.”

The “Manufactured” state in the state machine accepts the event “assign” where a consumer requests assignation of the AssetToken to become the owner of the AssetToken. In an embodiment, a business process with the manufacturer recognizes the assignation of the asset to a consumer and registers same with the assetToken. Once the “assign” event is fully processed, the state machine state becomes: “Owned.”

The “Owned” state in the state machine accepts the event “transfer” where an AssetToken owner initiates a transfer process of the AssetToken ownership to a new owner. Once the “transfer” event is fully processed, the state machine state becomes “In-Transfer.”

The “Owned” state in the state machine may accept the event “declare lost” where an AssetToken owner declares the AssetToken lost. Once the “declare lost” event is fully processed, the state machine state becomes “Lost.”

The “Owned” state in the state machine accepts the event “declare destroyed” where the AssetToken owner declares the AssetToken destroyed. Once the “declare destroyed” event is fully processed, the state machine state becomes “Destroyed.”

The “Owned” state in the state machine accepts the event “declare recycled” where the AssetToken owner declares the AssetToken recycled. Once the “declare recycled” event is fully processed, the state machine state becomes “Recycled.”

The state machine may contain the state “Lost.” The “Lost” state in the state machine accepts the event “declare found” where a user declares the asset represented by the AssetToken to be found. Once the “declare found” event is fully processed, the state machine state becomes “Found.”

The state machine may contain the state “Found.”

The “Found” state in the state machine accepts the event “found” where the owner of the AssetToken recognize the asset represented by the AssetToken was found after being lost. Once the “found” event is fully processed, the state machine state becomes “Owned.”

The “Found” state in the state machine may accept the event “declare not found” where the owner of the AssetToken does not recognize the asset represented by the AssetToken was found after being lost. Once the “declare not found” event is fully processed, the state machine state becomes “Lost.”

The state machine contains the state “Destroyed.”

The “Destroyed” state in the state machine accepts the event “finalize” where the system may no longer want to manage the AssetToken lifecycle. Once the event “finalize” is fully processed, the state machine state becomes “Final.”

The state machine contains the state “Recycled.”

The “Recycled” state in the state machine accepts the event “refurbished” where a participating business like a recycling 409 business refurbishes an asset and reflects a new status on the asset. An embodiment relies upon smart contracts 302 to automate this state transition process. Once the “refurbish” event is fully processed, the state machine state becomes “Refurbished.” Alternatively, state transitions are managed relying on a different process.

The “Recycled” state in the state machine accepts the event “finalize” where the system no longer want to manage the AssetToken lifecycle. Once the event “finalize” is fully processed, the state machine state becomes “Final.”

The “Refurbished” state in the state machine accepts the event “capture” where a consumer or a merchant links a refurbished asset to the AssetToken. Once the “capture” event is fully processed, the state machine state becomes “Owned.”

The state machine contains the state “In-Transfer.”

The “In-Transfer” state in the state machine accepts the event “own” where the transfer from one owner to a new owner is completed. Note that the new owner may also be the previous owner. Once the “own” event is fully processed, the state machine state becomes “Owned.”

The state machine contains one or more state called “Final.”

The final state “Final” no longer accepts events as the AssetToken in such state is no longer considered managed and no more changes to the AssetToken are recorded within the system. In the case the asset described by the AssetToken still exist and that a stakeholder is interested in managing the asset, a new AssetToken is created.

FIG. 10 illustrates the token privacy model 301C in one embodiment of the invention represented as a UML class diagram. The privacy model class 301C.1 contains permission associating a token info 301A.5 to any interested party 301C.2. An interested party class 301C.2 represents any party, user 2, mobile application 100, application backend 200, distributed ledger 300, business application 400, or participating business 3.

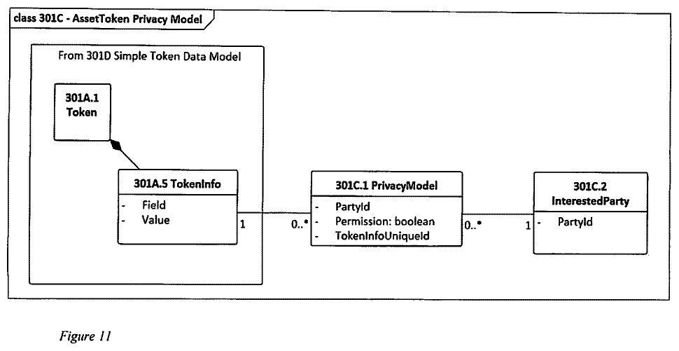

FIG. 11 is a simplified block diagram of privacy virtualization in a digital token distributed ledger model. Here information within the distributed ledger links to a privacy layer that is resolvable from the user side but can only be resolved from the ledger side with information provided by the user. Thus, the data in the ledger is anonymized relative to its digital existence. Obviously, if a user owns an Asset Token relating to a home at a specific address, then it is possible through physical world interactions to determine private information of the user.

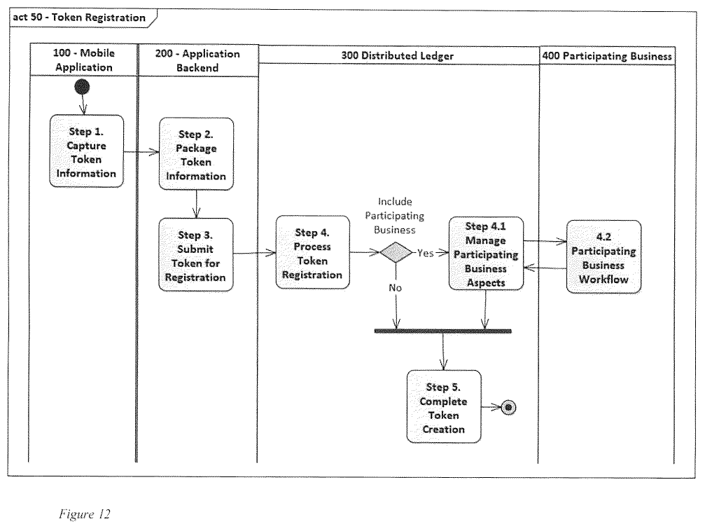

FIG. 12 illustrates an exemplary token registration workflow 50. The user 2 selected receipt, asset and events to register as token. At step 1, the mobile application 100 captures a digital representation of the receipt and extracts meaningful information that are part of the receipt. The mobile application 100 also captures data relating to the assets that are identified in the receipt and helps the user document asset details. The mobile application 100 also captures events and links these events to assets and to the receipt. The mobile application 100 implements a verify and submit button to request the application backend to register one or more tokens 301A.1.

At step 2, the application backend 200, validates the information on the submitted receipt, asset, and events, configures the token privacy model based on subscription 208 of the user and confirms the information is ready to be submitted for token registration. At step 3, the application backend 200 initiates the registration process using a smart contract 302. At step 4, the distributed ledger 300 executes the smart contract steps to register one or more tokens 401A.1. When the smart contract includes a participating business, at step 4.1, the distributed ledger 300 interacts with a participating business workflow. After Step 4 and Step 4.1 are completed, at Step 5, the distributed ledger 300 completes the registration and confirms token creation.

A typical loyalty program is based on dollar spent related to purchase transactions and involves only one consumer and one merchant. Some loyalty programs called multi-merchant loyalty programs manage relationships between one consumer and multiple merchants. Most loyalty programs offer information about consumer behaviour as a product. This means that participating in these programs involves giving up some privacy. In some cases, the warranty program offered by a manufacturer can be used as a proxy of a loyalty programs are rendered more flexible by having merchant, manufacturer, or other participating business offer incentives to the consumers in exchange for access to event tokens and asset tokens. Users can share information outside what seems relevant when they so choose. Optionally, users can share the information without sharing private data, for example without sharing their name. This provides a user with some control over their data and provides marketers and businesses with a treasure trove of available data to process.

For example, in one embodiment, a consumer may desire to purchase a good or service from a merchant. If the merchant is a participating business, the consumer my provide his/her user identification to the merchant and the merchant may generate the receipt token and associated asset tokens and event tokens in a name of the consumer. If the merchant is not a participating business, The consumer, using the mobile application, can register the receipt token and associated asset tokens and event tokens. The receipt token could be used to share details on the purchase, its associated assets, and events to a participating loyalty program. In this embodiment, the loyalty program can leverage the tokens in the distributed ledger and expand the program beyond the simple receipt information and add incentives related to the assets or asset event stored in the ledger. This is supported even if the user chooses to remain anonymous. For example, it may be important to know approximately where the user lives, but it may be inconsequential to know who the user is specifically. With the addition of many records that are anonymized, a loyalty program can extract much of what it currently extracts without individual identifying information needing to be stored or shared.

Typical insurance claims require manual reconciliation after the fact, where a person registering an insurance claim or the insurer produces a list of items that form part of the claim; these lists are often paper based or digital files formed from memory. However, this manual approach creates mistakes, fraud, delays, and missed elements of claims. However, given asset tokens relating to all valuable assets, a user can easily indicate on each token that it is damaged/missing as an event and then share their asset tokens with an insurer, which include model numbers, intervening events, etc. This optionally automates a claim process by relying on asset tokens, receipt tokens, and event tokens. The tokens are stored in a distributed verifiable ledger to offer a faster way to assemble elements of a claim, to standardize the documentation of each claim using a computer, a web application or a mobile application that automatically assembles a list for user verification using best practices and expected format. In some embodiments, the distributed ledger is accessible by a claims processing organization for automation, proof of verification, valuation, costing, replacement, and replacement assistance purposes, thereby reducing cost of processing claims, verifying claims and automating processing.

For example, a consumer experiences a fire. Using a mobile application, the consumer quickly assembles all detailed information stored in asset tokens relating to damaged or destroyed assets and information stored in receipt tokens associated with those assets and submits the ledger entries as part of their claim. The insurance company then has direct access to the tokens in the distributed ledger and accelerates a claim payment process, reducing cost, improving customer experience, and reducing fraud.

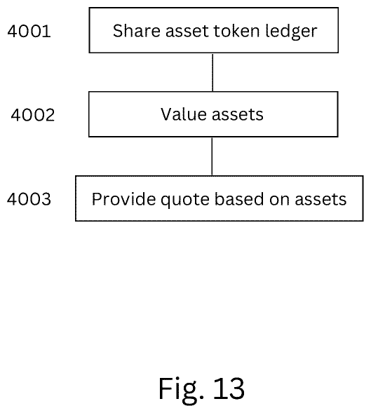

Referring to FIG. 13, shown is a method of generating an insurance quote. Here, a user provides to an insurance company access to the user's asset token ledger at 4001. At 4002, the insurance company values the assets and provides a quote at 4003 that specifically excludes some assets and includes others. The quote is for replacement of those specific assets. Thus, instead of providing a quote relating to some insured value, the quote is for specific assets and optionally includes coverage for other assets purchased during the term of the policy or likely assets like clothing that may not be reflected in the asset token ledger. Should a fire or theft occur, the insurance company can review the ledger with the insured to ensure that proper compensation is provided.

When making an insurance claim, a claimant provides tokens or receipts for claim approval. The insurance company approves the claim. The lost items are posted in an anonymous fashion for quotations; for example, all of one type of item are listed together—75 televisions, 55 laptops, and 116 video game consoles. Seeing 116 stolen video game consoles, a company bids to sell the insurance provider(s) all 116 video game consoles. Thus, the insurance provider can get a discount on identical items being replaced. The items are already in approved loss statements. The offer is based on a certain volume and lower volumes may require changes to the offer. That said, in an urban center there would be many claims in any given period of time and vendors would offer discounts to get volume orders from insurance companies.

In yet another example, a company wants to track replacement time for its products. At it asks of the business services server to return a number of consumers who own(ed) a specific product offered by the company and how many have already purchased a replacement of the product. The business services server then requests of the content distribution engine aggregated anonymised consumer insights. The content distribution engine processes private data to provide aggregated anonymised data to the consumer insights response store from which it is provided via the business services server to the business.

This request might return 63,000 products tokenised, 6,000 replaced within one year, 12,000 items replaced within two years and 45,000 replaced within three years. 64% of products replaced with Company's products. Now, that returned information is much better than 5% of products replaced with Company's products. The Company learns from this simple analysis that their product is generally only used for less than 3 years and is replaced within their own product 2 out of three times. This presents an opportunity to increase the 64% number in order to increase recurring revenue. It is evident that the information that is extractable from the digital tokens is of value; there is an opportunity for the consumer to benefit from a portion of this value.

Many people want to better understand their carbon footprint. This requires both a formula to calculate the carbon footprint based on assets and their usage, as well as the capacity for each person to assemble the information on assets and usage. However, this manual approach creates a very difficult task to create a measurement and maintain all the required information to continue measuring carbon footprint and benchmark the citizen against other people. However, embodiments of the present invention offer a reasonable formula that can be applied across all asset tokens and event tokens to measure and maintain measurement of carbon footprint. The usage of the same formula across all tokens offers the possibility to create benchmarking for people.

For example, a consumer, using a mobile application requests the application calculate his/her carbon footprint based on the asset tokens owned—associated with the consumer—and related events. The mobile application offers scenarios to reduce carbon footprint and offer a benchmarking report.

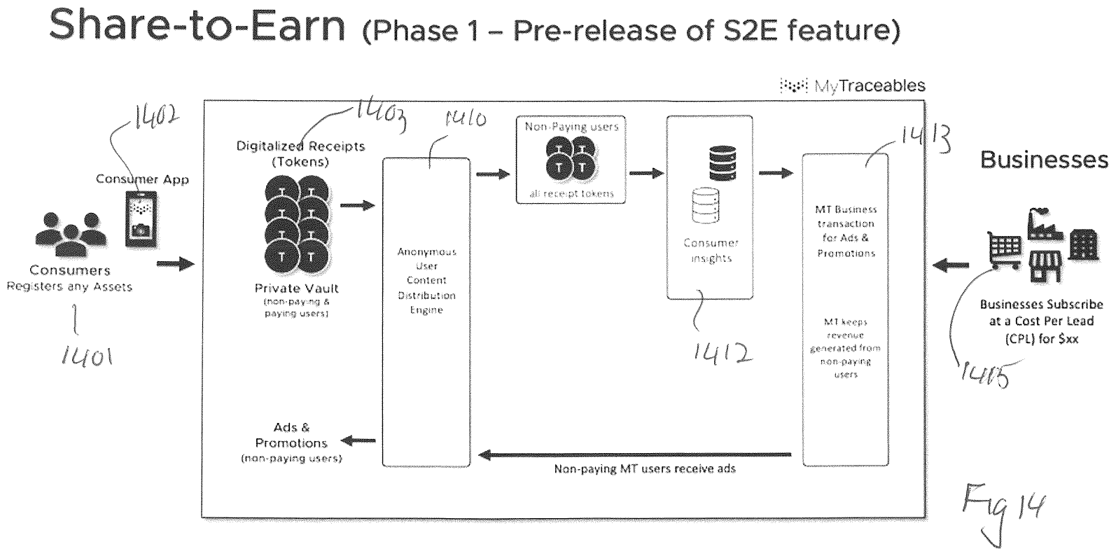

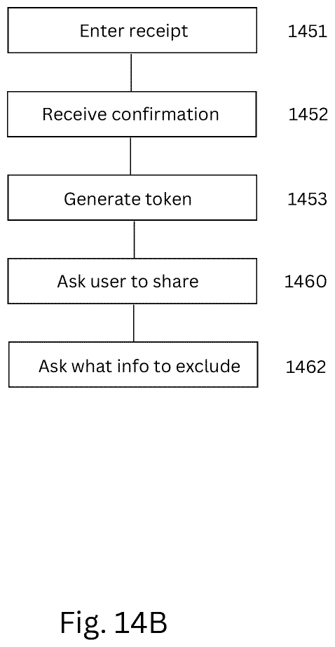

Referring to FIGS. 14 and 27, shown is a process for distribution of benefits within a tokenised asset environment wherein users of the environment choose to share information to earn benefits.

Referring to FIG. 14A, a consumer 1401 has a first asset. Assets are acquired through purchase, gift, creation, etc. The first asset belonging to the consumer is tokenised. The tokenisation is performed via a Consumer app 1402. The consumer app 1402 digitises a receipt for the first asset and transmits a digital representation to a server. For example, the digital representation is an image for being evaluated on the server. Alternatively, the image is processed within the consumer app and the digital representation is data extracted from the image for being provided to the server. At least a portion of the data is tokenised such that a digital token is formed reflecting the receipt and therefore reflecting ownership of the first asset by the consumer 1401. In FIG. 14a, this process of tokenisation is performed in a secure private process to maintain consumer confidence, with any data stored within a public blockchain being somewhat anonymised. Alternatively, all information is stored in private data stores. Further alternatively, all information is stored publicly available.

The digital tokens 1403 are stored in a private vault 1404 and provided in an anonymous or partially anonymous form to a content distribution engine 1410. Alternatively, the content distribution engine 1410 forms part of the secure private data store and releases data on a non-private side thereof only after consolidating and anonymising said data.

Here, digital tokens 1403 are converted into aggregate anonymised information in the form of consumer insights 1412 for use in a business services server 1413 which offers services to businesses 1414 in the form of subscribing businesses. Examples of the flow of information are presented herein below for enhancing understanding of the architecture.

A first business of the subscribing businesses has subscribed and asked to be notified of any consumer that has a washing machine that is 7 years old or older. The business services server 1413 requests information from the anonymous user content distribution engine 1410 and periodically is advised of consumers 1401 who have washing machines that are over 7 years old, as requested. The content distribution engine 1410 need not inform the business services server 1413 of any private information. The first business can communicate to each identified consumer an advertisement or an offered benefit via the content distribution engine such that the first business and even the business services server 1413 do not know identifying information about the consumers. Still, each consumer with an old washing machine receives a message from the first business 1415. Because the private vault includes digital data relating to a first purchase date and model of each washing machine that is tokenised, the first business can customise their offer/advertisement based on machine age, features, efficiency, etc. A typical offer might state that the first business offers a washing machine that will save you 30$ per month and will pay for itself in 2 years and 2 months vs the current washing machine that you own, the model XXX. Thus the offer optionally includes very specific information for a consumer. That said, the consumer knows that the information is provided to them without their information being shared.

In an embodiment, a user opts in to participating in the overall system. In another embodiment, the user shares in a benefit such as a portion of the subscription fees earned by the system. In yet another embodiment, consumers can set preferences for what is shared, what is not shared, and what is shared at a cost. Thus, in some embodiments consumers' privacy and preferences are supported.

In another embodiment, the first business sends an advertisement to consumers who fit a certain profile without knowing who they are. For example, I want to send out an advertisement for home insurance to all owners of Wolf® appliances because they are in my demographic. Alternatively, I want to send out a notice of an upcoming wine auction to all owners of a certain brand of wine cooler. In yet another example, consumers who purchase baby furniture are placed on a list to receive ads relating to their children 6 years later, etc. Of course, when consumers opt in, such a network architecture is beneficial and yet remains private.

In another exemplary process, an insurance company seeking to replace an item sends offers to each person with that same item tokenised. Thus, a numbered signed print of an artist's work is replaceable because each owner of the work is contacted and the insurance company negotiates a “best” price. The insured can then have the item replaced by the insurance company or the insurance company can pay a minimum amount as the item replacement value. The negotiation, pricing, etc. can all be handled anonymously such that who owns the artwork is unknown unless they choose to sell it and the insurance company chooses to purchase it.

Shown in FIG. 14B, a user enters their receipt for automobile insurance into the system at 1451. The user receives an email confirmation from their insurance provider at 1452, and generates a token within the system at 1453; here, the token is a receipt token and an event token; Alternatively, only one of a receipt token and event token are generated. The receipt token includes information relating to the receipt. The event token includes the type of event, insurance renewal or new insurance policy; the event start date; the event duration. Optionally, the event token also includes the insurance company and information about the vehicle insured. The event token is of a type that is recognised to be of value. At 1460, the user is asked if they wish to share renewal information with other insurance companies. In return, they are made an offer having an offered benefit based on what the insurance companies will pay for such a lead. Offers typically refer to a payment, such as each insurance company will pay $5, the offered benefit, if you choose to share the token information with them. In some cases offers will be in the form of an offer related to services. For example, a company may offer to discount their typical quote by 100$ if the user shares their event token. In the example of FIG. 14, the user is offered the opportunity to exclude specific companies from those with whom information is shared at 1462. The user is also offered to limit sharing based on a maximum number of companies or a minimum earning value at 1462. Ideally, in return for sharing the user is offered a payment and a discount on insurance.

Of course, when the insurance is on a new car, then an event token is generated for a New Car. This leads to information that can be shared about services for a new car and about upgrading to a different car in the future.

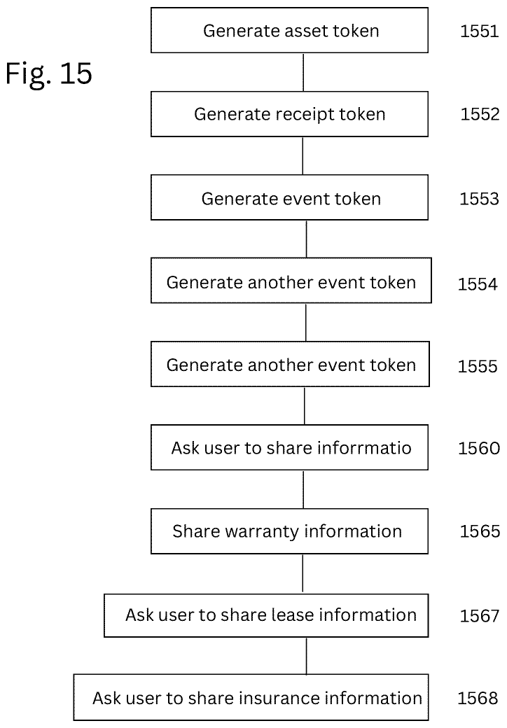

Referring to FIG. 15, shown is a process for generating tokens for leasing a new car. An asset token is generated at 1551 representative of the car model, year and features. A receipt token is generated at 1552 representative of the “purchase” price, dealer, date, etc. Though cars are automatically registered by dealers when purchased new, the receipt token acts as a reminder/verification for warranty related events. An event token is generated at 1553 representing registration of the vehicle including its state, registration date, owner, and VIN number. Another event token is generated at 1554 representing the lease including the lease start and end date, purchase price at the end of the lease, lease payments, taxes, and interest rate. Another event token is generated at 1555 representing insurance on the vehicle and including insurance provider, insurance rate, coverage terms, vehicle or vehicles, etc. Thus, many variables relating to the car purchase/lease event are recorded in tokens.

At 1560, a user of the system who has leased the car is prompted at any point between purchase and expiry of an event to share information in order to earn money or rewards. For example, the user chooses at 1565 to share the warranty event token with extended warranty providers, the extended warranty providers may offer an improved warranty in the present or an extended warranty when the present warranty ends. Alternatively, the extended warranty provider offers both. Because extended warranty providers compete, the user gets both a benefit in the competition and gets paid to share their information. Similarly, the user is asked if they want to share their lease information at 1567. The lease information is shared with car dealers and car buyers who can offer to purchase the car when the lease expires, can offer to trade in the car when the lease expires, can try to sell the user a new car when the lease expires, etc. Thus, the user gets paid to share information, but the information is valuable to car dealers and purchasers who can secure well treated cars at the end of their lease. As noted above, the user is asked if they want to share their insurance information at 1568. The user is also asked if they want to share their lease information with lenders. Other lenders may happily compete to offer lower rates to someone already in a lease for a vehicle. The lenders may also offer leases on other products to the user. Of course, there are many suppliers who would want to have access to the information generated with a purchase of a new car. Alternatively, the user of the system is prompted after expiry of an event.

In another embodiment, tokens such as event tokens are not recorded in a blockchain and are instead tokens within a private database. Further alternatively, tokens are data within a private database of the user.

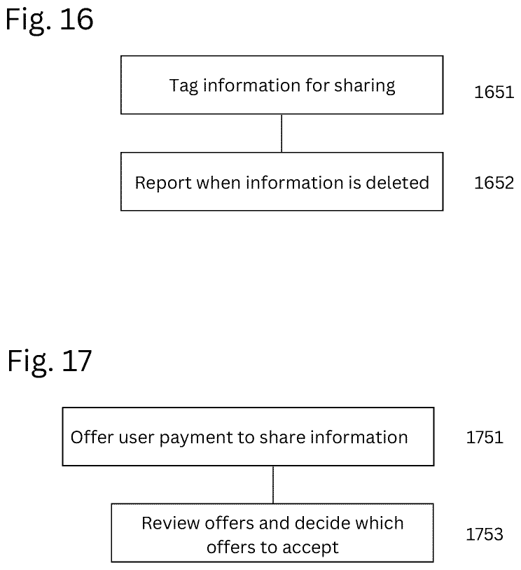

Referring to FIG. 16, shown is a method of sharing information that is secure. One problem with sharing any information in today's age of technology is that it can be passed around because information has value. For example, when a first person fills out any form that asks for private information, this information can be used to put the first person on call lists and mailing lists. By using different initials, it is a straightforward matter to trace from where information is being shared. However, to stop the information sharing, requires the first person to stop filling out all forms, because the first person does not know beforehand which forms will be shared.

In the flow diagram of FIG. 16, a process is shown for tagging the information when shared at 1651 and for reporting at 1652 when the shared information is deleted. If the information appears in any call lists or mail lists, the information tagging is used to try to identify a source of the information and thereby stop any information leaks. In some embodiments, the information is shared in a fashion that prevents bulk copying such that sharing is only supported by copying the information, either manually or photographically. Since most vendors will enter the information into their own systems, such a limitation is limiting to the vendors. As such, information tagging and export are supported to allow for tracing of information use to limit the effects of unscrupulous vendors and/or to warn users of unscrupulous vendors.

Referring to FIG. 17, shown is a simplified flow diagram of a method of interactively negotiating information sharing deals. At 1751, a first user is offered a payment, an offered benefit, in return for sharing their information. The payment offered benefit is tied to the information shared, the number of competitors with whom it is shared, and a discount being offered. The first user looks through all the offers and decides at 1753 which offers to accept and which offers to reject. For example, an insurance provider offers 10$, an offered benefit, if there are three or fewer insurance providers who get access to the information and 2$ otherwise. The first user might feel better sharing with three insurance providers for 10$, 10$, and 8$ respectively, than with 16 insurance providers at 2$ each. The first user selects an option that suits them. In another example, an insurance provider offers 10$ to the first user or 6$ and a 5% discount to be applied to the insurance offer when it is made. Of course, insurance providers will determine reasonable payments based on cost of customer acquisition, the type of customer, and a competitiveness of the landscape.

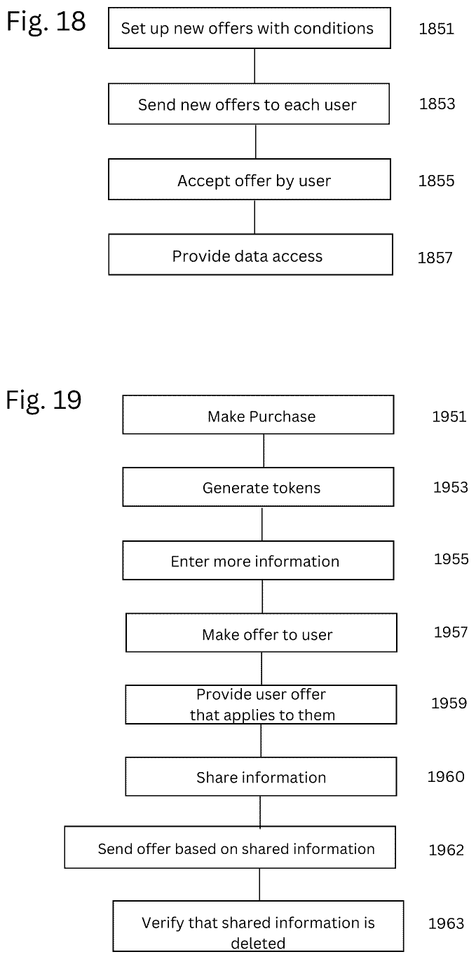

Referring to FIG. 18, shown is a simplified flow diagram of an insurance company making an offer including an offered benefit. Here, the insurance company defines specified data in the form of information relevant to its offers. At 1851 the insurance company sets up N offers, each for individuals in different insurance brackets. At 1853 the entire offer package is sent to the first user, and at the first user system, the offer package is disambiguated to show the first user the offer that is for them based on their private data. The offer is then accepted or rejected by the first user at 1855. If rejected, the insurance provider does not know which offer was rejected. If accepted, at 1857 the insurance provider has access to the data and therefore knows which offer was accepted. The same blind multiple offer approach is supported in many share-to-earn applications. For example, a car dealership may offer a different reward for a purchaser of an inexpensive car than for a purchaser of a luxury car. The car dealership need not know which car the first user purchased. Instead, both offers are bundled together and disambiguated for the first user in confidence, either at the first user system or at a trusted intermediary server.

Referring to FIG. 19, shown is a simplified flow diagram of an exemplary process. At 1951, a first user makes purchases, subscribes to services, purchases insurance and leases a car. At 1953 tokens are generated relating to each receipt, each event, and each asset.

At 1955, the first user decides to enter further information into the system, the further information relating to employment, housing, and other credit related information.

At 1957 a first provider makes an offer, contingent upon certain criteria. Since the first user meets those criteria, at 1959 the first user is provided the offer in the form of the offer is displayed in a list of offers. The first user reviews each offer and evaluates same. For example, each offer is evaluated based on the information requested, the use of the information, the payment offered, and the benefits offered should the first user purchase from the first provider. Further limitations within offers are also evaluated.

The first user selects offers to accept at 1960 and shares information with those providers, including the first provider.

At 1962 the first provider sends an offer to the first user based on the shared information.

At 1963 the first provider verifies that the information is deleted once it has been used. This may happen immediately or may require months depending on the information and when the first provider needs same.

In some embodiments, benefits to the first user are non-financial benefits. For example, a hospital asks for access to health information of the first user and the “payment” is a message indicating a risk level of the first user for a certain ailment or disease.

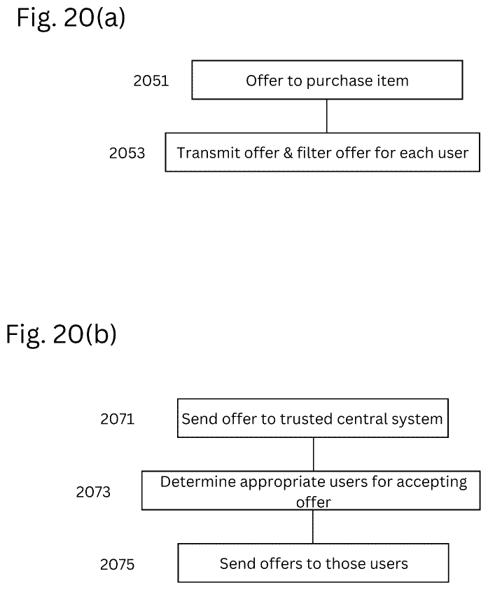

Referring to FIG. 20, shown are two flow diagrams for a process of replacing an item that has been lost or damaged. In a first flow diagram, that of FIG. 20(a), an offer to potentially purchase an item is made at 2051 to each individual having the item. The offer is sent to everyone and at 2053 on each individual's system the offer is filtered based on whether the individual entertains such offers and whether the individual has the item. In contrast, in the flow diagram of FIG. 20(b), the offer is sent to a central trusted system at 2071. The central trusted system might be a distributed system, a service provider, a series of service providers or a fully distributed blockchain. In any event, at 2073 the trusted system determines those individuals with the item who accept offers and at 2075 only forwards the offer to those individuals.

In another exemplary process, an insurance company seeking to replace an item sends offers to each person with that same item tokenised. Thus, a numbered signed print of an artist's work is replaceable because each owner of the work is contacted, and the insurance company negotiates a “best” price. The insured can then have the item replaced by the insurance company or the insurance company can pay a minimum amount as the item replacement value. The negotiation, pricing, etc. can all be handled anonymously such that who owns the artwork is unknown unless they choose to sell it and the insurance company chooses to purchase it.

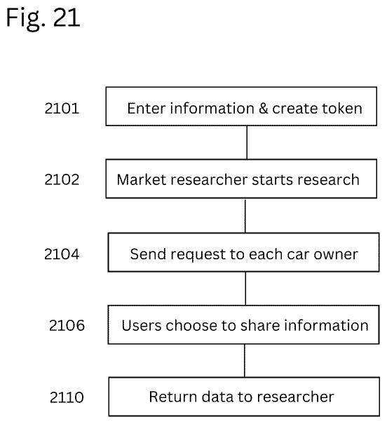

In some embodiments of the invention, the process is applied to research. For example, healthcare research or market research. Referring to FIG. 21 shown is a simplified flow diagram of a method of applying an embodiment to research in the form of market research.

At 2101, a first user enters personal information into their profile and creates or has created a plurality of tokens. At 2102, a market researcher seeks answers to specific anonymised questions such as the age of people who own Ford® Mustang® convertibles. At 2104 the information request is transmitted and each owner of a Ford® Mustang® convertible, individuals with asset tokens of a Ford® Mustang® convertible, is asked to participate in the market research. At 2106, individuals who accept to participate in the market research, provide their age and the year of their Mustang®. Other users are counted—a total number of Mustang® owner's is reported—but no information is retrieved about them. At 2110 the market researcher is returned data in the following format: total mustang owners, total reporting, and then the age data in groups:
16 years: 45
17 years: 47 . . . .

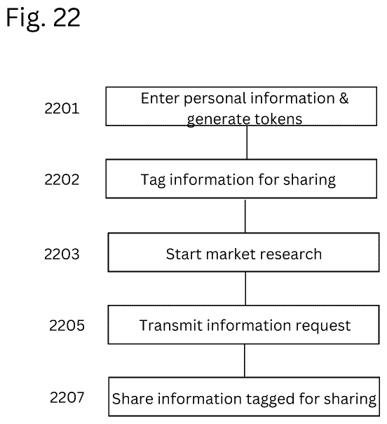

Referring to FIG. 22 shown is another simplified flow diagram of a method of applying an embodiment to research in the form of market research.

At 2201, a first user enters personal information into their profile and creates or has created a plurality of tokens. At 2202, the first user tags information that can be shared with researchers without prior permission. At 2203, a market researcher seeks answers to specific questions such as the age of people who own Ford® Mustang® convertibles. At 2205, the information request is transmitted to each owner of a Ford® Mustang® convertible, that has agreed to participate in research. At 2207, when the requested information is of a type that is sharable, then the system provides an age and the year of the associated Mustang®. The market researcher is returned data in the following format: total reporting, and then the age data in groups:
16 years: 45
17 years: 47 . . . .

Of note, the total number of mustang owners is not reported as some individuals have chosen to maintain their information private. Alternatively, a total number is reported either derived from anonymised user data or derived from other public sources.

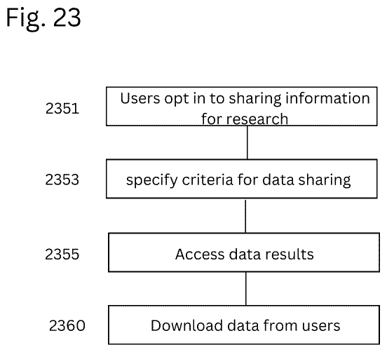

Referring to FIG. 23, shown is a generic market research application. At 2351, users including the first user opt-in to market research projects, either individual projects or groups of projects. At 2353 each user specifies the type of research, the anonymity of data shared, the minimum payment for data sharing etc., resulting in customised data access criteria. Then at 2355 a market researcher can access data results without user permission and can slice and dice the data in various ways in order to achieve their research goals. For example, a market researcher wants to know about owners of Mustang®s broken down by age, sex, and so forth. At 2360 the researcher downloads the specified data from the users that have opted in and that accept the amount the researcher is willing to pay. The resulting specified data includes significant anonymised data including Mustang® ownership by neighbourhood, by driving record, by age, by sex, by credit score, by home ownership, as part of one car and two car homes, by boat ownership, etc. The resulting data set is rich, mostly accurate, anonymous, and collectible in minutes from a computer terminal.

When the market research is completed at 2362, the data is archived securely with a trusted service provider and deleted locally such that user data security is maintained while maintaining the underlying data for the research so it can be verified later if need be.

During use, an analytics database populated with the data allows for any number of data searches, reviews, analyses, etc. In some embodiments, data is linked to the data owner, the users, in an anonymous fashion such that further messaging or research is conductable with the first user's consent. In other embodiments data is segmented into hierarchies wherein accessing higher level data requires further payment and/or further permission. At the ultimate level, a researcher could contact a user directly with the user's permission. It is foreseen that for medical research users would often want to speak directly with a researcher to discuss results that are significant to said user, such as health risks.

In some embodiments, data is hashed to provide anonymous links between data and its owner. In other embodiments data is hashed to provide data usable in grouping users into categories that are either ill understood or are known but determinable without access to underlying data.

Advantageously, by knowing that a user is a woman between 45 and 50 who owns a mustang, it is possible to message that woman or that group in order to request access to further data or to request direct conversation. It is also possible to send an offer to all those women once they are identified, or even absent identifying them.

In some implementations, a consumer pays to prevent sharing of their information. Here, the consumer agrees to share anonymised information. Some users pay a subscription fee to control sharing of anonymised information as indicated in their preferences. Optionally, the consumers that pay a subscription also share in some of the revenue generated based on their information, for example, they are offered additional discounts. Alternatively, they share in the revenue generated based on their tokens. Further alternatively, they share in the revenue generated based on all tokens.

For example, the consumers use a mobile app to capture receipt information in the form of a receipt photograph for use in extracting purchase and asset data. The purchase and asset data is tokenised within digital tokens and stored in a secure content distribution engine. The distribution server communicates with a paywall, in the form of paywall with a free tier and a paid tier, to determine what data is shareable and in what form. In some embodiments, there is no free tier. For example data relating to tokens of a first set of users in a first subscription tier have anonymised information shared in unlimited quantities and for unlimited purposes. Subscribers in a second other tier have their anonymised information shared for market research and for receiving special offers for repairing, upgrading or replacing assets. Subscribers in a third tier have their anonymised information shared for market research, for special offers, and to sell collectable assets, for example to insurance companies to replace damaged or destroyed assets.

The three-tier system described allows consumers to control how their information is used and to benefit commercially through the anonymous offering of their assets on an open but anonymous network.

Another embodiment supports a fourth tier. Here, a business makes a request. The secure content distribution engine determines which consumers' data is used in responding to the request. A fourth tier of consumers is notified before their information is shared and either each consumer opts in or out based on the notice. For example, a notice offering $10 for sharing some information is accepted and another notice offering 10$ for other information is refused. A request to provide appliance upgrade offers is refused but requests to purchase tokenised assets are accepted. In such a system, the consumer still is provided a preferences module to limit a number of requests received, but is now capable of responding to requests for information that include offering something in return.

Only data from consumers who have authorised the use of their data is used in formulating a response and the response is provided to the business. Of course, not all users are in the fourth tier so typically, data relating to users in other tiers is used but only data of users in the fourth tier who have authorised a use of their data is included in the analysis.

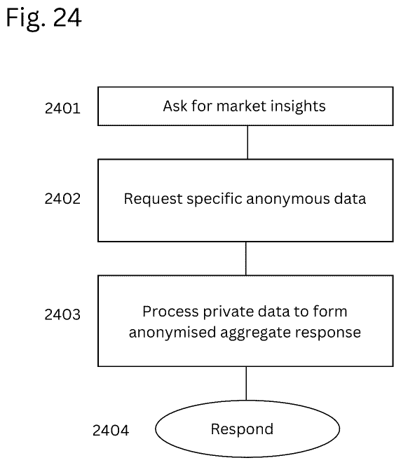

Referring to FIG. 24, shown is a simplified diagram of a method of generating market insights. Here, market insight processes are pre-programmed, for example they are saved from previous uses. A user selects an insight they want returned at 2401 and at 2402 the system requests specified data. At 2403 the data is processed to provide anonymized aggregate response data and then at 2404 the market insight is provided to the user. Because the market insight was previously programmed, the process is as simple as the press of a button.

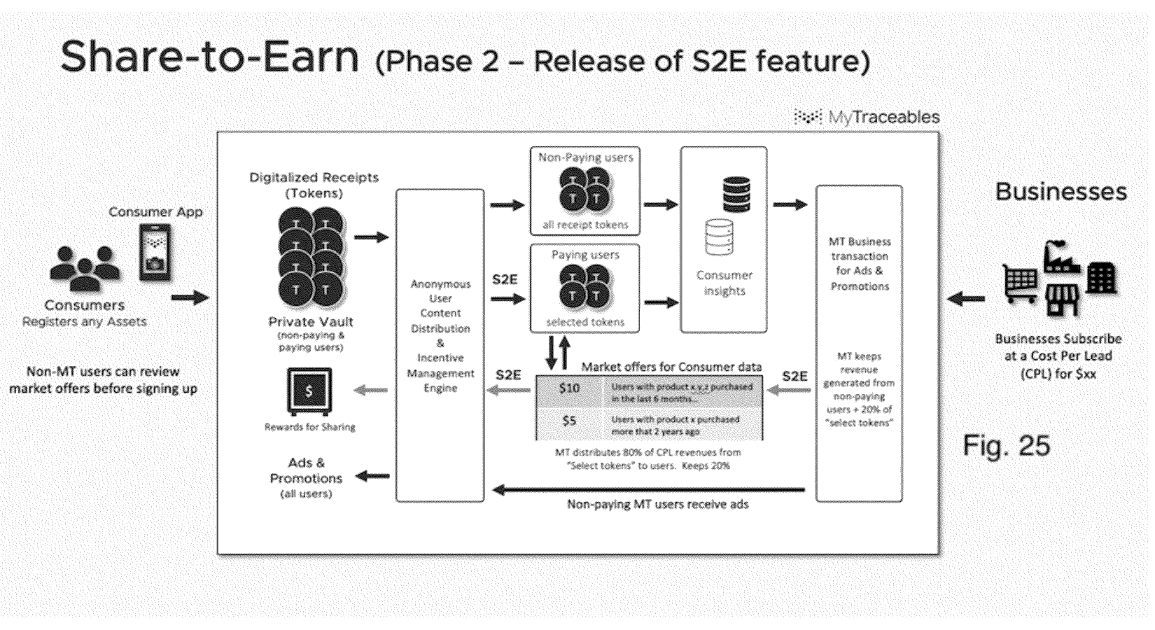

Referring to FIG. 25, shown is a simplified diagram of an architecture of a share to earn data storage and access. The architecture shown is generalised to allow user registration and storage of data along with an access for businesses to extract insights. The architecture is shown including optional components and user data privacy implementation.

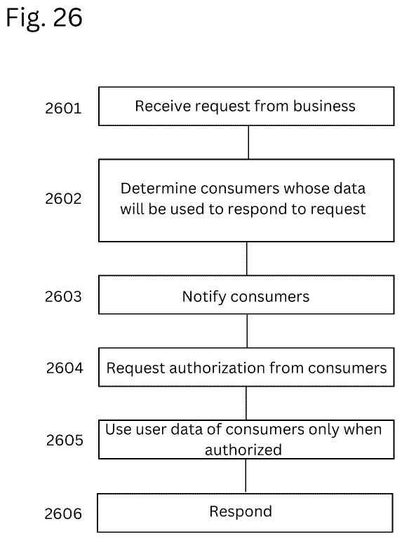

Referring to FIG. 26, shown is a simplified flow diagram of a method of conducting research. A business provides a request at 2601. At 2602, the request is parsed for whose information is needed. For example, if information is sought regarding mid-life heart disease, then only users in mid-life are approached. At 2603 those users identified are the sent notices at 2604. Each notice requests user authorisation to access specified data in the form of user information. Typical notices include an offered benefit and request the specified data. At 2605, only data from users who authorised use of their specified data is used in responding to the business request. At 2606 a response is provided to the business.

When digitised receipts relate to uncommon assets, such as collectibles, the system allows for monitoring collectible transactions, offers, and data gathering to assist all parties involved in tracking products and markets. This is highly advantageous for seasonal collectible products or where product markets change in a fashion that when known is advantageous.

Other digital tokens, that are not described herein, are typically part of disparate centralized or decentralized databases in relation with entities that generate the tokens. However, embodiments of the present invention may offer a consumer centric insight on the digital token transactions, additional information and events that capture within or associated with receipt tokens, asset tokens and event tokens.

It should be understood that the present invention as described above may be implemented in the form of control logic using a processor with suitable computer software for execution thereon, whether in a modular or integrated manner. Alternatively, the process is executable with a custom processing device. Further alternatively, the process is executable on numerous suitably programmed processors in parallel or serially or in a distributed fashion.

Any of the software components or functions described in this application, may be implemented as Software code to be executed by a processor using any Suitable computer language such as, for example, Java, Javascript or Python using, for example, conventional or object-oriented techniques. The Software code may be stored as a series of instructions, or commands on a computer readable medium, Such as a random-access memory (RAM), a read only memory (ROM), a magnetic medium Such as a hard-drive or a floppy disk, or an optical medium such as a CD-ROM. Any such computer readable medium may reside on or within a single computational apparatus and may be present on or within different computational apparatuses within a system or network.

One or more features from any embodiment may be combined with one or more features of any other embodiment without departing from the scope of the invention. In some embodiments, the term asset and asset token is replaced with item and asset token, where an asset token relates to an item. The embodiments described are equally applicable to non-financial items such as collectables or sentimental items as they are to items of having financial value.

The above description is illustrative and is not restrictive. Many variations of the invention may become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
providing a first set of data stored in an electronically accessible form and stored in association with a first user;
receiving by the first user an offer from a first offeror to provide access to specified data within the first set of data to a third-party in return for an offered benefit;
accepting by the first user the offer; and
in response to accepting by the first user permitting the third-party access to the specified data.

2. A method according to claim 1 wherein the first set of data is stored within a blockchain, data within the first set of data secured with a user private key associated with the first user.

3. A method according to claim 1 wherein the first set of data is stored within the cloud, data within the first set of data secured with a user private key associated with the first user.

4. A method according to claim 1 comprising providing to the first user the offered benefit.

5. A method according to claim 4 wherein the offered benefit is held in escrow by an electronic system and wherein the electronic system releases the offered benefit when it has access to the specified data.

6. A method according to claim 4 wherein the offered benefit is a monetary benefit.

7. A method according to claim 3 wherein upon accepting the offered benefit, a system of the first user retrieves first data secured with a private key associated with the first user and provides second data to the third-party.

8. A method according to claim 7 wherein the second data is watermarked for supporting identifying of the second data by the first user.

9. A method according to claim 1 comprising:
processing the offer by at least one of a broker and a system of the first user to determine if the offer is applicable to the first user; and
when the offer is determined to apply to the first user providing the offer to the first user for review.

10. A method according to claim 1 comprising:
Automatically processing the offer by at least one of a broker and a system of the first user to determine if the offer is an offer that is acceptable to the first user; and
when the offer is determined to be acceptable to the first user automatically accepting the offer.

11. A method according to claim 7 wherein the second data is verifiable against the secured first data to determine its accuracy.

12. A method comprising:
providing an offer to first users comprising: specifying an offered benefit, transmitting to each of the first users the offer comprising an indication of specified data to access in return for the offered benefit.

13. A method according to claim 12 wherein providing an offer comprises specifying characteristics of each first user for receiving the offer and filtering users based on the characteristics to determine the first users, each of the first users for receiving the offer.

14. A method according to claim 12 wherein providing an offer comprises specifying characteristics of each first user for receiving the offer and characteristics of the first users as a group and filtering users in accordance with the characteristics to determine the first users, each of the first users for receiving the offer.

15. A method according to claim 12 wherein providing an offer comprises specifying characteristics of each first user for receiving the offer and characteristics of the first users as a group; providing the offer with the specified characteristic to a plurality of users including the first users; and filtering by users who receive the offer and in accordance with the characteristics to determine if a given user who receives the offer is one of the first users.

16. A method comprising:
providing an offer to first users comprising: specifying an offered benefit, transmitting to each of the first users the offer comprising an indication of specified data to access in return for the offered benefit;
providing a first set of data stored in an electronically accessible form and stored in association with a first user;
receiving by the first user an offer to provide access to specified data within the first set of data to a third-party in return for the offered benefit;
accepting by the first user the offer; and
in response to accepting by the first user the offer, permitting the third-party access to the specified data.

17. A method comprising:
providing a first asset token owned by a first user;
transmitting to the first user an offer to permit a third-party access to token information associated with the asset token; and
accepting by the first user the offer to permit access, thereby granting to the third-party access to the token information.

18. A method according to claim 17, wherein 3rd party access is temporary having a known end date and time.

19. A method according to claim 17, wherein third-party access is restricted to predetermined data.

20. A method according to claim 17 wherein the first user remains anonymous.

21. A method according to claim 17, wherein the 3rd party is a marketplace for offering an item associated with the first asset token for sale.
